(19) United States
(12) Patent Application Publication
(10) Pub. No.: US 2007/0144283 A1
(43) Pub. Date: Jun. 28, 2007

(54) Power Transmission Apparatus

(76) Inventors: Toshiyuki Hasegawa, Amagasaki-shi (JP); Shuji Nishimoto, Amagasaki-shi (JP); Kazunari Koga, Amagasaki-shi (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/564,791

(22) Filed: Nov. 29, 2006

(30) Foreign Application Priority Data
Nov. 30, 2005 (JP) 2005-346925
Dec. 5, 2005 (JP) 2005-351068
Oct. 18, 2006 (JP) 2006-284365

(51) Int. Cl. F16H 3/08

(52) U.S. Cl. 74/325

(57) ABSTRACT

A power transmission apparatus interposed between a prime mover and an axle, comprising: an automatic continuously variable belt transmission serving as a main transmission; and a gear transmission serving as a sub-transmission. The sub-transmission includes input means for receiving power from the main transmission, output means for outputting power to the axle, a first gear train interposed between the input means and the output means so as to have a first deceleration ratio, a first clutch disposed on the first gear train, a second gear train interposed between the input means and the output means so as to have a second deceleration ratio which is different from the first deceleration ratio, and a second clutch disposed on the second gear train. The first clutch is engaged when a rotary speed of the input means is not smaller than a threshold value, and the second clutch is engaged unless the first clutch is engaged. Alternatively, the first clutch is disengaged when a road-load applied onto the axle is not smaller than a threshold value, and the second clutch is engaged when the first clutch is disengaged.

### BACKGROUND OF THE INVENTION

1. Field of the Invention

The present invention relates to a power transmission apparatus applicable to working vehicles, e.g., trucks. The power transmission apparatus is interposed between a prime mover and an axle. The power transmission apparatus includes a main transmission and a sub-transmission driven by the main transmission. The main transmission is an automatic continuously variable belt transmission. The sub-transmission is a gear transmission, for instance.

2. Related Art

Conventionally, as disclosed in JP 2003-194097 A, there is a vehicle equipped with a power transmission apparatus interposed between a prime mover and an axle. The power transmission apparatus includes an automatic continuously variable belt transmission (hereinafter, referred to as “CVT”) serving as a main transmission, and a gear transmission serving as a sub-transmission driven by the main transmission.

The sub-transmission is manually operated for changing its speed level. This onerous manual operation has to be performed only when the vehicle is stationary. If a manipulator for speed-changing the sub-transmission is operated by accident during traveling of the vehicle, the unexpectedly set speed level of the sub-transmission becomes disproportionate to the rotary speed of the axle, thereby reducing a power transmission efficiency, reducing a torque, or stalling the prime mover at worst.

Further, conventionally, when the prime mover rotary speed exists within the idle rotary speed range, the belt tension of the CVT is zeroed so as to automatically set the CVT into the neutral state. However, the vehicle with such a CVT is hard to creep on a slope. Further, the vehicle must start with slipping of the belt, so that the belt has a short life and requires frequent maintenance. If the CVT is designed to keep a belt tension when the prime mover rotary speed is within the idle rotary speed range, the vehicle can creep and the life of the belt can be prolonged. However, there is a question of how to establish the neutral state of the CVT.

Further, in the conventional power transmission apparatus including the CVT, an output shaft of the prime mover and an input shaft of the sub-transmission (e.g., a gear transmission) on the downstream side of the CVT are disposed in parallel, so as to serve as pulley shafts for the CVT. A CVT casing for protecting the CVT from dust and water also serves as a connection member for connecting the prime mover to a transmission casing incorporating the sub-transmission. However, if the power transmission apparatus has to be adaptable to various prime movers (whether the prime mover is vibration-isolated or not, whether the prime mover is a diesel engine or a gasoline engine, or whether the power of the prime mover is large or small), a plurality of CVT casings designed corresponding to the respective prime movers have to be prepared, thereby increasing costs.

The only CVT casing is enough for the various prime movers if the CVT and the CVT casing are independent of the prime movers and disposed at a place unconcerned to types of the prime movers. However, in this case, the power transmission apparatus is required to have a space in which an input means of the CVT can be unrestrictedly designed in correspondence to the respective types of the prime movers.

### SUMMARY OF THE INVENTION

A first object of the present invention is to provide a power transmission apparatus interposed between a prime mover and an axle, comprising: an automatic continuously variable belt transmission serving as a main transmission; and a gear transmission serving as a sub-transmission, wherein the sub-transmission is automatically gear-shifted.

To achieve the first object, in a first aspect of the invention, in a power transmission apparatus interposed between a prime mover and an axle, comprising: an automatic continuously variable belt transmission serving as a main transmission; and a gear transmission serving as a sub-transmission, the sub-transmission includes input means for receiving power from the main transmission, output means for outputting power to the axle, a first gear train interposed between the input means and the output means so as to have a first deceleration ratio, a first clutch disposed on the first gear train so as to be engaged when a rotary speed of the input means is not smaller than a threshold value, a second gear train interposed between the input means and the output means so as to have a second deceleration ratio which is different from the first deceleration ratio, and a second clutch disposed on the second gear train so as to be engaged unless the first clutch is engaged. Therefore, the first clutch is automatically engaged or disengaged according to change of the rotary speed of the input means of the sub-transmission, and the second clutch is engaged or disengaged according to the engagement or disengagement of the first clutch, thereby automatically selecting one of the first and second deceleration ratios.

Preferably, in the first aspect, the first gear train serves as a high-speed gear train, and the second gear train serves as a low-speed gear train. Therefore, an optimal speed level of the sub-transmission corresponding to the traveling condition of the vehicle can be surely selected between the high-speed level and the low-speed level automatically without onerous manual gearshift operation.

Preferably, in the first aspect, the first clutch is a centrifugal clutch or a hydraulic clutch. Therefore, the first clutch is configured so as to be automatically engaged or disengaged according to the rotary speed change of the input means.

Preferably, in the first aspect, the second clutch is an overrunning clutch, a hydraulic clutch or a dog clutch. Therefore, the second clutch is configured so as to be engaged or disengaged in association with the engagement and disengagement of the first clutch, thereby automatically selecting one of the first and second deceleration ratios.

Alternatively, to achieve the first object, in a second aspect of the invention, in a power transmission apparatus interposed between a prime mover and an axle, comprising: an automatic continuously variable belt transmission serving as a main transmission; and a gear transmission serving as a sub-transmission, the sub-transmission includes input means for receiving power from the main transmission, output means for outputting power to the axle, a first gear train interposed between the input means and the output means so as to have a first deceleration ratio, a first clutch disposed on the first gear train so as to be disengaged when a road-load applied onto the axle is not smaller than a threshold value, a second gear train interposed between the input means and the output means so as to have a second deceleration ratio which is different from the first deceleration ratio, and a second clutch disposed on the second gear train so as to be engaged when the first clutch is disengaged. Therefore, the first clutch is automatically engaged or disengaged according to change of the road-load applied onto the axle during traveling of a vehicle, and the second clutch is engaged or disengaged according to the engagement or disengagement of the first clutch, thereby automatically selecting one of the first and second deceleration ratios.

Preferably, in the second aspect, detection means is disposed on the downstream side of the first and second gear trains so as to detect the road-load applied onto the axle, and the first clutch is engaged or disengaged based on a value of load detected by the detection means. Therefore, a vehicle equipped with the power transmission apparatus including the detection means requires no additional detection means for detecting the road-load.

Preferably, in the second aspect, the first gear train serves as a high-speed gear train, and the second gear train serves as a low-speed gear train. Therefore, an optimal speed level of the sub-transmission corresponding to the traveling condition of the vehicle can be surely selected between the high-speed level and the low-speed level automatically without onerous manual gearshift operation.

Preferably, in the second aspect, in the main transmission, a belt is interposed between a first shaft connected to the prime mover and a second shaft connected to the sub-transmission, and the belt slips when the main transmission is overloaded. The power transmission apparatus further comprises: first detection means for detecting a rotary speed of the first shaft; and second detection means for detecting a rotary speed of the second shaft. The first clutch is engaged or disengaged based on detection values of the first and second detection means. Therefore, the first clutch is controlled based on rotary speeds of the respective first and second shafts of the main transmission detected by the first and second detection means, thereby requiring no additional detection means for detecting the road-load as mentioned above. Consequently, the number of components is reduced and the power transmission apparatus is minimized.

Further preferably, the first gear train serves as a high-speed gear train, and the second gear train serves as a low-speed gear train. Therefore, an optimal speed level of the sub-transmission corresponding to the traveling condition of the vehicle can be surely selected between the high-speed level and the low-speed level automatically without onerous manual gearshift operation.

Further preferably, when a rotary speed of the first shaft is constant, a detected rotary speed of the second shaft defined for disengaging the first clutch having been engaged is smaller than a detected rotary speed of the second shaft defined for engaging the first clutch having been disengaged. Therefore, a hysteresis occurs in gearshift by switching the first clutch so as to prevent the sub-transmission from being excessively frequently gearshifted between the high-speed level and the low-speed level.

Preferably, in the second aspect, the first clutch is a hydraulic clutch. Therefore, the first clutch is configured so as to be automatically engaged or disengaged according to the road-load.

Preferably, in the second aspect, the second clutch is an overrunning clutch. Therefore, the second clutch is configured so as to be engaged or disengaged in association with the engagement and disengagement of the first clutch, thereby automatically selecting one of the first and second deceleration ratios.

Alternatively, preferably, in the second aspect, the first and second clutches are wet disk clutches. Therefore, the first and second clutches can be compactly integrated with each other, and can be supplied with fluid from a common hydraulic pressure source.

Preferably, in either of the first and second aspects, a vehicle speed for switching between the first gear train and the second gear train is set in a range lower than a half of the maximum vehicle speed. Therefore, the first gear train is mainly selected for traveling of a vehicle, and the second gear train is selected in rare cases (e.g., for emergency).

Preferably, in either of the first and second aspects, the sub-transmission further includes: a third gear train for transmitting power bypassing the first and second gear trains to the output means; and a third clutch disposed on the third gear train. A direction of rotation of the output means driven by the third gear train is different from a direction of rotation of the output means driven by either of the first and second gear trains. Therefore, the first and second gear trains and the third gear train prepare two different directions of rotation outputted to the axle, and the vehicle can selectively travel either forward or backward by selecting one of the first, second and third gear trains.

Further preferably, the third gear train has a third deceleration ratio which is larger than one of the first and second deceleration ratios that is smaller than the other of the first and second deceleration ratios. Therefore, the vehicle is effectively driven to travel at a low speed caused by the third deceleration ratio which is larger than the smaller one of the first and second deceleration ratios.

Preferably, in either of the first and second aspects, the main transmission is disposed opposite to the prime mover with respect to the sub-transmission. Therefore, the configuration of housing the main transmission is economically standardized regardless of types of the prime movers.

Further preferably, the sub-transmission supports the main transmission and is vibro-isolatedly mounted on a vehicle frame. Therefore, the main transmission and the sub-transmission in the power transmission apparatus are prevented from troubles caused by vibration.

Preferably, the main transmission disposed opposite to the prime mover with respect to the sub-transmission further comprises a cover enclosing substantially all over the main transmission. Due to the cover, the automatic continuously variable belt transmission serving as the main transmission is protected from dust and water. In the state that the main transmission is disposed opposite to the prime mover with respect to the sub-transmission, when the cover is opened, the main transmission is widely exposed so as to facilitate maintenance. Further, the cover enclosing substantially all over the automatic continuously variable belt transmission serving as the main transmission can be standardized regardless of change of a type of the prime mover.

A second object of the invention is to provide a power transmission apparatus interposed between a prime mover and an axle, the power transmission apparatus including an automatic continuously variable belt transmission serving as a main transmission; and a gear transmission serving as a sub-transmission driven by the main transmission, wherein, when the prime mover idles, the power transmission apparatus can be automatically set into a neutral state while a vehicle is ready to creep.

To achieve the second object, in a third aspect of the invention, a power transmission apparatus interposed between a prime mover and an axle comprises: an automatic continuously variable belt transmission serving as a main transmission; a gear transmission serving as a sub-transmission driven by the main transmission; and a centrifugal clutch disposed on the upstream side of the sub-transmission. The centrifugal clutch is disengaged when a rotary speed of the prime mover exists within an idle rotary speed range. The centrifugal clutch is engaged when the rotary speed of the prime mover exceeds the idle rotary speed range. Therefore, when the prime mover idles, the neutral state of the power transmission apparatus is established by disengaging the centrifugal clutch while constantly keeping a tension of the belt of the automatic continuously variable belt transmission serving as the main transmission, such as to transmit power through the main transmission, so that the centrifugal clutch is engaged for creeping the vehicle immediately after the rotary speed of the prime mover exceeds the maximum idle rotary speed.

Preferably, in the third aspect, the power transmission apparatus further comprises an overrunning clutch. When a rotary speed of the upstream side of the centrifugal clutch is lower than a rotary speed of the downstream side of the centrifugal clutch, the overrunning clutch is engaged to transmit power bypassing the centrifugal clutch. Therefore, when the vehicle descends a slope, in the centrifugal clutch, the downstream side rotary speed exceeds the upstream side rotary speed, so as to engage the overrunning clutch for transmitting power bypassing the centrifugal clutch, thereby ensuring an effective engine brake (i.e., dynamic brake by the prime mover).

Preferably, in the third aspect, the power transmission apparatus further comprises a regulation gear train disposed on the upstream side of the main transmission so as to regulate a rotary speed of power from the prime mover inputted to the main transmission. Therefore, the rotary speed of power inputted to the main transmission is kept substantially constant regardless of a rated rotary speed of a prime mover selected among prime movers having different rated rotary speeds, e.g., whichever is selected between a gasoline engine having a high rated rotary speed and a diesel engine having a low rated rotary speed.

Preferably, in the third aspect, the centrifugal clutch is interposed between the regulation gear train and the main transmission. Therefore, when the prime mover idles, the main transmission, the sub-transmission and the axle are set in neutral.

Alternatively preferably, in the third aspect, the centrifugal clutch is interposed between the main transmission and the sub-transmission. Therefore, when the prime mover idles, the sub transmission and the axle are set in neutral while the main transmission is driven.

Preferably, the power transmission apparatus in either first or second aspect include the configuration of the third aspect. Therefore, the effect by the third aspect is added to the effect by the first or second aspect.

A third object of the invention is to provide a power transmission apparatus disposed in front or rear of a prime mover of a vehicle and between front and rear axles so as to transmit power from the prime mover to the front and rear axles, the power transmission apparatus comprising: an automatic continuously variable belt transmission; a second transmission driven by the belt transmission, wherein a configuration of housing the belt transmission can be economically standardized regardless of change of a type of the prime mover.

To achieve the second object, in a fourth aspect of the invention, a power transmission apparatus is disposed in front or rear of a prime mover of a vehicle and between front and rear axles so as to transmit power from the prime mover to the front and rear axles. The power transmission apparatus comprises: an automatic continuously variable belt transmission; a second transmission driven by the belt transmission a casing incorporating the second transmission; and input means for transmitting power from the prime mover to the belt transmission. The belt transmission is disposed opposite to the prime mover with respect to the casing in the fore-and-rear direction of the vehicle. The input means is supported by the casing so as to penetrate the casing through front and rear surfaces of the casing. Therefore, the configuration of housing the belt transmission is standardized regardless of change of a type of the prime mover, thereby reducing costs. On the other hand, since the input means of the belt transmission for inputting power from the prime mover is supported by the casing so as to penetrate the casing through front and rear surfaces of the casing, the casing is provided therein with a space for various arrangements corresponding to different types of prime movers.

Preferably, in the fourth aspect, the power transmission apparatus further comprises a cover enclosing substantially all over the belt transmission. Due to the cover, the belt transmission is protected from dust and water. In the state that the belt transmission is disposed opposite to the prime mover with respect to the second transmission, when the cover is opened, the belt transmission is widely exposed so as to facilitate maintenance. Further, the cover enclosing substantially all over the belt transmission can be standardized regardless of change of a type of the prime mover.

Preferably, the second transmission includes: a front output shaft for transmitting power to the front axle; and a rear output shaft for transmitting power to the rear axle. Either a propeller shaft connecting the front output shaft to the front axle or a propeller shaft connecting the rear output shaft to the rear axle is disposed on either left or right side of the prime mover. Therefore, these propeller shafts are prevented from interfering with the prime mover, so that the front and rear output shafts do not have to be vertically offset from the prime mover, thereby ensuring compactness of the power transmission apparatus and the vehicle.

Preferably, in the fourth aspect, the input means includes a regulation gear train disposed in the casing so as to regulate a rotary speed of power from the prime mover inputted to the belt transmission. Therefore, while the casing is provided therein with a space for various arrangements corresponding to different types of prime movers, the rotary speed of power inputted to the belt transmission is kept substantially constant due to the regulation gear train, regardless of a rated rotary speed of a prime mover selected among prime movers having different rated rotary speeds, e.g., whichever is selected between a gasoline engine having a high rated rotary speed and a diesel engine having a low rated rotary speed.

These, further and other objects, features and advantages will appear more fully from the following description with reference to accompanying drawings.

### BRIEF DESCRIPTION OF THE DRAWINGS

FIG. 1 is a side view of a working vehicle (a truck) employing a power transmission apparatus according to the present invention.

FIG. 2 is a plan view of the working vehicle.

FIG. 3 is a sectional side view of a first power transmission apparatus in which a sub-transmission automatically gearshifts based on detection of its input rotary speed.

FIG. 4 is a sectional rear view of the representative first power transmission apparatus showing arrangement of a low-speed forward-traveling gear train with a low-speed forward-traveling clutch in the sub-transmission.

FIG. 5 is a fragmentary sectional side view of the representative first power transmission showing a limited slip type center differential unit.

FIG. 6 is a fragmentary sectional side view of the representative first power transmission apparatus showing another limited slip type center differential unit.

FIG. 7 is a sectional side view of a second power transmission apparatus in which a sub-transmission automatically gearshifts based on detection of its input rotary speed.

FIG. 8 is a sectional side view of a third power transmission apparatus in which a sub-transmission automatically gearshifts based on detection of its input rotary speed.

FIG. 9 is a sectional rear view of the representative third power transmission apparatus showing arrangement of a low-speed forward-traveling gear train with a low-speed forward-traveling clutch in the sub-transmission and a rotary speed sensor for detecting an input rotary speed of the sub-transmission.

FIG. 10 is a sectional side view of a fourth power transmission apparatus in which a sub-transmission automatically gearshifts based on detection of its input rotary speed.

FIG. 11 is a sectional side view of a fifth power transmission apparatus in which a sub-transmission automatically gearshifts based on detection of its input rotary speed.

FIG. 12 is a sectional side view of a principal portion of a sixth power transmission apparatus in which a sub-transmission automatically gearshifts based on detection of its input rotary speed.

FIG. 13 is a fragmentary sectional side view of a principal portion of a seventh power transmission apparatus in which a sub-transmission automatically gearshifts based on detection of its input rotary speed.

FIG. 14 is a graph of traction effort relative to vehicle speed due to the clutch control of the (first to seventh) power transmission apparatus in which the sub-transmission automatically gearshifts based on detection of its input rotary speed.

FIG. 15 is a sectional plan view of an eighth power transmission apparatus in which a sub-transmission automatically gearshifts based on detection of road-load torque.

FIG. 16 is a fragmentary sectional plan view of the representative eighth power transmission apparatus showing arrangement of a hydraulic pump and a regulation gear train.

FIG. 17(a) is a fragmentary sectional view of the representative eighth power transmission apparatus showing a torque sensor and a hydraulic high-speed forward-traveling clutch with a hydraulic circuit diagram, and FIG. 17(b) is a fragmentary sectional view of the torque sensor in the rotation direction thereof.

FIG. 18 is a sectional plan view of a ninth power transmission apparatus in which a sub-transmission automatically gearshifts based on detection of road-load torque.

FIG. 19 is a sectional plan view of a principal portion of a tenth power transmission apparatus in which a sub-transmission automatically gearshifts based on detection of road-load torque.

FIG. 20 is a sectional plan view of a principal portion of an eleventh power transmission apparatus in which a sub-transmission automatically gearshifts based on detection of road-load torque.

FIG. 21 is a graph of traction effort relative to vehicle speed due to the clutch control of the (eighth to eleventh) power transmission apparatus in which the sub-transmission automatically gearshifts based on detection of road-load.

FIG. 22 is a fragmentary sectional rear view of a twelfth power transmission apparatus in which a sub-transmission automatically gearshifts based on detection of rotary speeds of respective first and second shafts of CVT, regarded as detection of road-load torque.

FIG. 23 is a diagram indicating a map for setting a speed level of a gear transmission relative to the detected rotary speeds of the respective first and second shafts of the CVT in the twelfth power transmission apparatus.

FIG. 24 is a diagram indicating a map for setting a speed level of the gear transmission relative to the detected rotary speed of the second shaft of the CVT when the power transmission apparatus is controlled due to the map of FIG. 23, and when the first shaft of the CVT is rotated at the maximum speed.

### DETAILED DESCRIPTION OF THE INVENTION

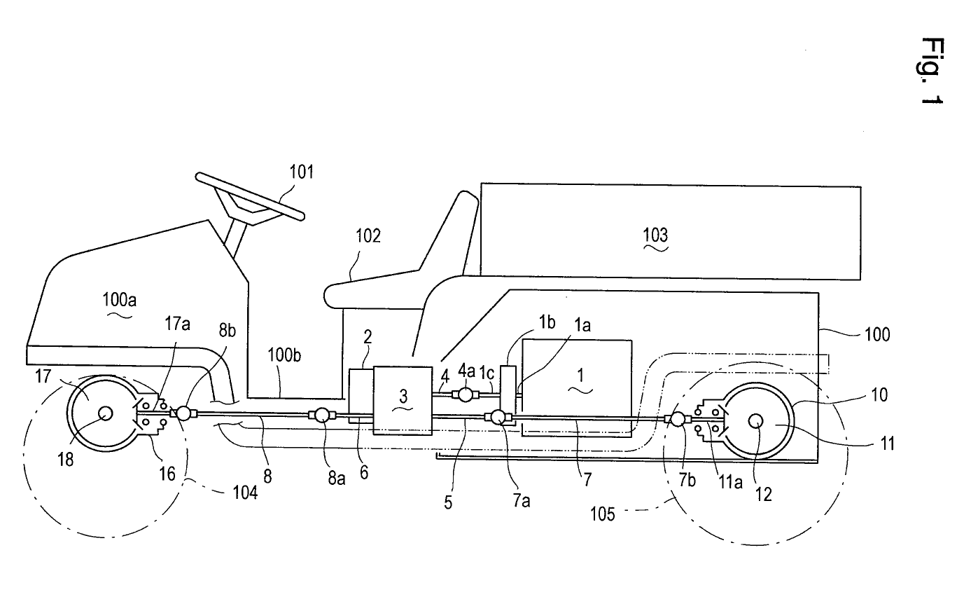

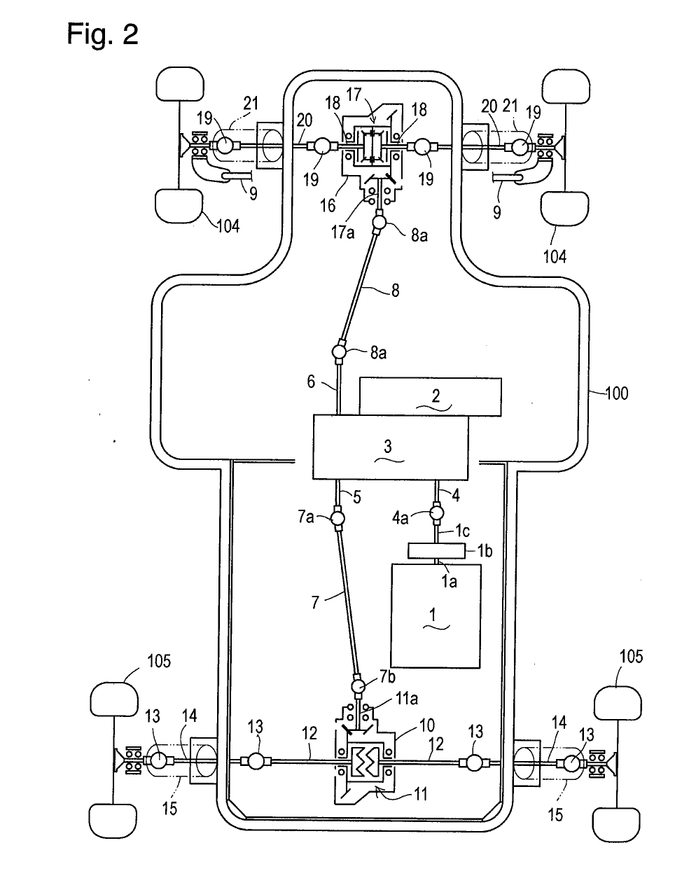

FIGS. 1 and 2 illustrate an entire working vehicle (truck) equipped with a power transmission apparatus according to the invention. A general configuration of the working vehicle will be described. A body frame 100 is formed thereon with a platform 10b. A bonnet 100a is mounted on body frame 100 in front of platform 100b. A steering wheel 101 projects upward from bonnet 100a so as to turn steerable front wheels 104. A rear portion of body frame 100 behind platform 100b rises by a step. A driver's seat 102 is mounted on a front top portion of the rising rear portion of body frame 100, and a cargo 103 is disposed on the rising rear portion of body frame 100 behind driver's seat 102.

A prime mover 1, e.g., an engine, is elastically supported (vibro-isolatedly mounted) through vibration-isolating rubbers (not shown) on body frame 100 below cargo 103. A gear transmission casing 3 incorporating a gear transmission serving as a sub-transmission is disposed in front of prime mover 1, and elastically supported (vibro-isolatedly mounted) through vibration-isolating rubbers (not shown) on body frame 100 below cargo 103, similar to prime mover 1. A CVT casing 2 is formed integrally on a front surface of gear transmission casing 3, so as to incorporate an automatic continuously variable belt transmission (CVT) serving as a main transmission. Gear transmission casing 3 and CVT casing 2 are disposed under driver's seat 102, as shown in FIG. 1. Preferably, driver's seat 102 is forwardly rotatable so that gear transmission casing 3 and CVT casing 2 can be exposed for maintenance by forwardly rotating driver's seat 102.

Prime mover 1 has a forwardly projecting horizontal output shaft 1a. A flywheel 1b is provided on a front end of output shaft 1a. Gear transmission casing 3 has a rearwardly projecting horizontal input shaft 4. Input shaft 4 is connected at a rear end thereof to flywheel 1b through a universal joint 4a and a propeller shaft 1c so as to transmit power of prime mover 1 to input shaft 4.

A horizontal rear output shaft 5 projects rearward from a lower portion of gear transmission casing 3, and a horizontal front output shaft 6 projects forward from the lower portion of gear transmission casing 3 coaxially opposite to rear output shaft 5. Input means for inputting power to the CVT, including input shaft 4, penetrates gear transmission casing 3 and projects forward from gear transmission casing 3 so as to be drivingly connected to the CVT in CVT casing 2. The output power from the CVT is transmitted to rear and front output shafts 5 and 6 through the gear transmission in gear transmission casing 3. The gear transmission includes means for selecting a traveling direction of the vehicle between forward and backward, so as to selectively rotate output shafts 5 and 6 in either the forward traveling direction or the backward traveling direction.

Since the CVT is disposed opposite to prime mover 1 with respect to gear transmission casing 3, CVT casing 2 is standardized in design regardless of difference of prime movers. Further, in gear transmission casing 3 is ensured a large space for various arrangements of the input means for inputting power to the CVT, including input shaft 4, and various arrangements of the gear transmission in correspondence to types of the prime movers.

Vehicle frame 100 supports a rear axle housing 10 behind prime mover 1. Rear axle housing 10 supports a pair of left and right rear axles 12, and incorporates a differential gear unit 11 differentially connecting axles 12 to each other. Each of rear axles 12 is drivingly connected to each of rear wheels 105 through universal joints 13 and a propeller shaft 14, as shown in FIG. 2. Further, each of suspensions 15 (e.g., coil springs or air cylinders) is interposed between body frame 100 and each of rear wheels 105, so as to support rear axle housing 10 vertically movably relative to rear wheels 105.

A horizontal input shaft 11a of differential gear unit 11 projects forward from rear axle housing 10 so as to be connected to rear output shaft 5 through universal joints 7a and 7b and a propeller shaft 7, thereby transmitting power from the gear transmission in gear transmission casing 3 to rear wheels 105. Due to universal joints 7a and 7b, rear propeller shaft 7 is disposed on one of left and right sides of prime mover 1, i.e., laterally offset from prime mover 1, so as to be prevented from interfering with prime mover 1.

Body frame 100 supports a front axle housing 16 under bonnet 100a. Front axle housing 16 supports a pair of left and right front axles 18, and incorporates a differential gear unit 17 differentially connecting front axles 18 to each other. Each of front axles 18 is drivingly connected to each of front wheels 104 through universal joints 19 and a propeller shaft 20, as shown in FIG. 2. Further, each of suspensions 21 (e.g., coil springs or air cylinders) is interposed between body frame 100 and each of front wheels 104, so as to support front axle housing 16 vertically movably relative to front wheels 104.

A horizontal input shaft 17a of differential gear unit 17 projects rearward from front axle housing 16 so as to be connected to front output shaft 6 through universal joints 8a and 8b and a propeller shaft 8, thereby transmitting power from the gear transmission in gear transmission casing 3 to front wheels 104.

Front wheels 104 are steerably connected to respective front axles 18, and connected to each other through a tie rod 9 operatively connected to steering wheel 101, so that front wheels 104 are turned left or right according to rotation of steering wheel 101, thereby turning the vehicle.

Further, on body frame 100 are disposed unshown manipulators (such as a lever and a pedal) to be operated by a driver sitting seat 102, e.g., a manipulator for changing the traveling direction of the vehicle between forward and backward, and a brake operation device.

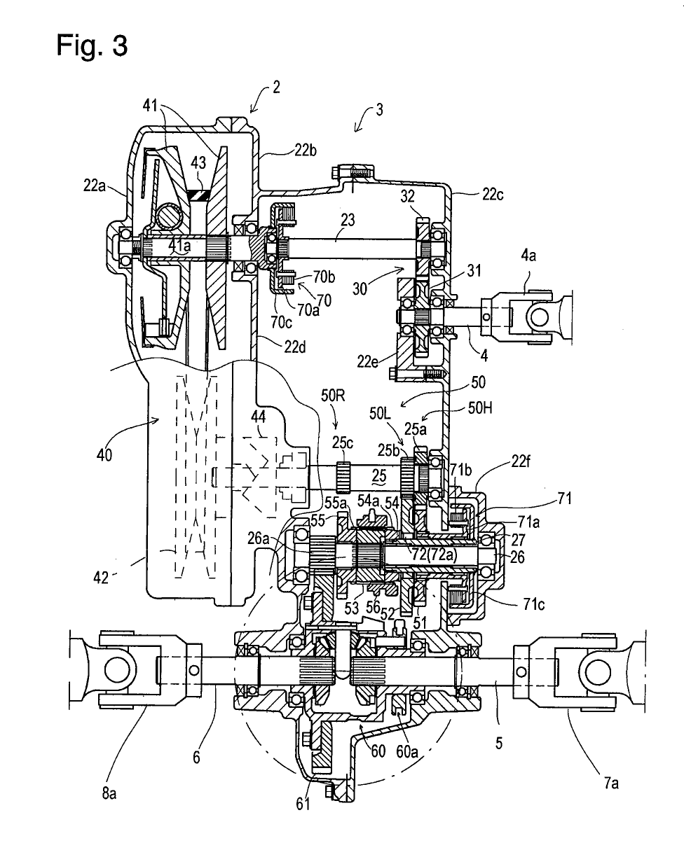

Hereinafter, description will be given of first to eleventh power transmission apparatuses according to the invention with reference to FIGS. 3 to 21. In each of the power transmission apparatuses, CVT casing 2 incorporating a CVT 40 is formed integrally with gear transmission casing 3 incorporating input shaft 4, a gear transmission 50, and rear and front output shafts 5 and 6. CVT 40 serves as a main transmission. Gear transmission 50 serves as a sub-transmission driven by CVT 40. CVT 40 and gear transmission 50 are drivingly interposed between input shaft 4 and output shafts 5 and 6.

A common structure shared among all the first to eleventh power transmission apparatuses will be described. As shown in representative FIG. 3, in each of the first to eleventh embodiments, a front casing part 22a, a middle casing part 22b and a rear casing part 22c are joined together so as to constitute CVT casing 2 and gear transmission casing 3. Middle casing part 22b is formed at a fore-and-aft intermediate portion thereof with a vertical partition wall 22d. A forwardly opened portion of middle casing part 22b expanded forward from partition wall 22d serves as a rear half of CVT casing 2, and a rearwardly opened portion of middle casing part 22b expanded rearward from partition wall 22d serves as a front half of gear transmission casing 3. A rear open end of front casing part 22a is joined to the front open end of middle casing part 22b so as to constitute CVT casing 2. A front open end of rear casing part 22c is joined to the rear open end of middle casing part 22b so as to constitute middle casing 3. Preferably, casing parts 22a, 22b and 22c are separably fastened to one another by bolts.

The joint surface between front and middle casing parts 22a and 22b is disposed rearward of CVT 40, i.e., close to partition wall 22d toward gear transmission casing 3. Therefore, front casing part 22a serves as a cover enclosing substantially all over CVT 40, so that, when front casing part 22a is removed from middle casing part 22b, the whole of CVT 40 excluding the rear surface thereof is exposed. Therefore, the power transmission apparatus incorporating all components including a later-discussed regulation gear train 30 and gear transmission 50, excluding CVT 40, can serve as a product to which a buyer can easily attach CVT 40. If the power transmission apparatus includes CVT 40, by detaching front casing part 22a, the almost entire portion of CVT 40 can be exposed so as to facilitate maintenance of components, e.g., a belt, of CVT 40.

A bearing wall 22e is formed in a rear portion of gear transmission casing 3 consisting of middle and rear casing parts 22b and 22c. A front portion of input shaft 4 is inserted into the rear portion of gear transmission casing 3 and journalled by bearing wall 22e through a bearing. A fore-and-aft horizontal main drive shaft 23 is disposed in parallel to input shaft 4 in gear transmission casing 3, journalled at a rear end thereof by the rear wall of gear transmission casing 3 (i.e., rear casing part 22c), and drivingly connected to an input pulley 41 of CVT 40 disposed in CVT casing 2.

In gear transmission casing 3, regulation gear train 30 drivingly connects input shaft 4 to main drive shaft 23. In other words, input shaft 4, regulation gear train 30 and main drive shaft 23 serve as input means of CVT 40. In regulation gear train 30, a gear 31 is fixed on input shaft 4, a gear 32 is fixed on main drive shaft 23, and gears 31 and 32 mesh with each other.

When the power transmission apparatus is drivingly connected to any of prime movers having different rated rotary speeds, e.g., whether prime mover 1 is a diesel engine having a low rated rotary speed or a gasoline engine having a high rated rotary speed, the gear ratio of regulation gear train 30 interposed between the prime mover and CVT 40 is adjusted by changing diameters of gears or the number of gears or in another way, thereby easily ensuring a constant input rotary speed of CVT 40, i.e., a constant rotary speed of main drive shaft 23. Therefore, many kinds of CVTs or gear transmissions having different specs do not have to be prepared in correspondence to different prime movers, i.e., CVT 40 and gear transmission 50 can be standardized, thereby reducing costs.

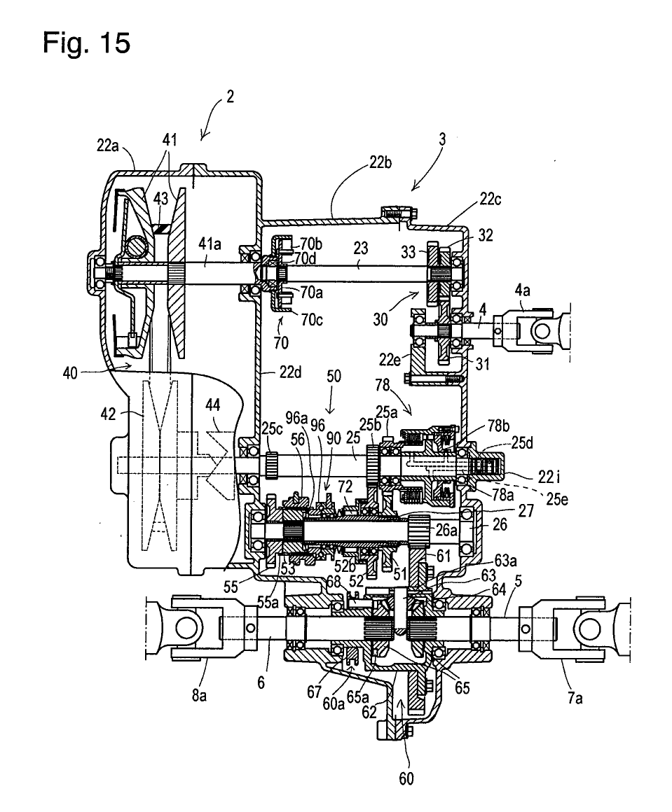

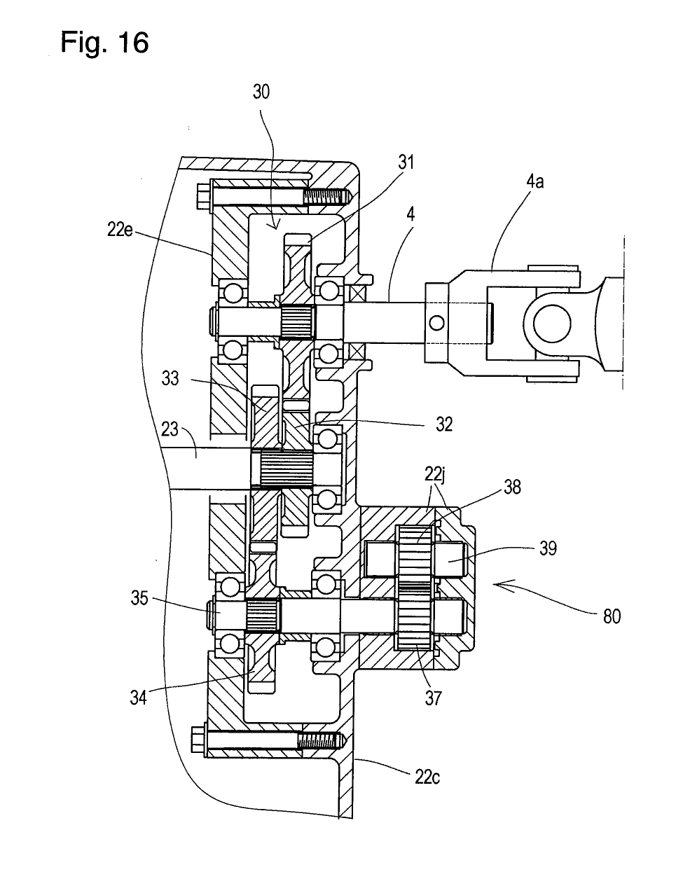

With respect to the eighth and ninth power transmission apparatuses, as shown in FIGS. 15, 16 and 18, a gear 33 is fixed on main drive shaft 23 adjacent to gear 32 so as to drive a hydraulic pump 80 for supplying fluid to a later-discussed hydraulic high-speed forward-traveling clutch 78. As shown in FIG. 16, gear-pump type hydraulic pump 80 is mounted onto gear transmission casing 3 so as to be driven by main drive shaft 23. Hydraulic pump 80 is set to deliver an optimal amount of fluid corresponding to a certain rated rotary speed of a kind of prime mover. Since the delivery amount of fluid from hydraulic pump 80 has to be rated regardless of difference of prime mover 1, a gear train is interposed between main drive shaft 23 driven by input shaft 4 through regulation gear train 30 and hydraulic pump 80 so as to correspond to the rotary speed of input shaft 4 and the gear ratio of regulation gear train 30.

In this regard, as shown in FIG. 16, a fore-and-aft horizontal pump drive shaft 35 is disposed in parallel to input shaft 4 and main drive shaft 23, and journalled by gear transmission casing 3. Pump drive shaft 35 is journalled at a front end thereof by bearing wall 22e through a bearing. A gear 34 is fixed on pump drive shaft 35, and meshes with gear 33 fixed on main drive shaft 23. A gear pump casing 22j is fixed onto the rear surface of gear transmission casing 3, i.e., the rear surface of rear casing part 22c, so as to project rearward. Pump drive shaft 35 projects rearward from the rear end wall of gear transmission casing 3 so as to be journalled in gear pump casing 22j. In gear pump casing 22j, a fore-and-aft horizontal pump driven shaft 39 is journalled in parallel to pump drive shaft 35, a gear 37 is fixed on pump drive shaft 35, a gear 38 is fixed on pump driven shaft 39, and gears 37 and 38 mesh with each other, so as to constitute hydraulic pump 80 contained in gear pump casing 22j.

Alternatively, high-speed forward-traveling clutch 78 may be supplied with fluid from another fluid source, and hydraulic pump 80 shown in FIG. 16 supplies fluid to another hydraulic pressure-controlled implement, e.g., a hydraulic actuator for vertically moving cargo 103 in the truck shown in FIGS. 1 and 2.

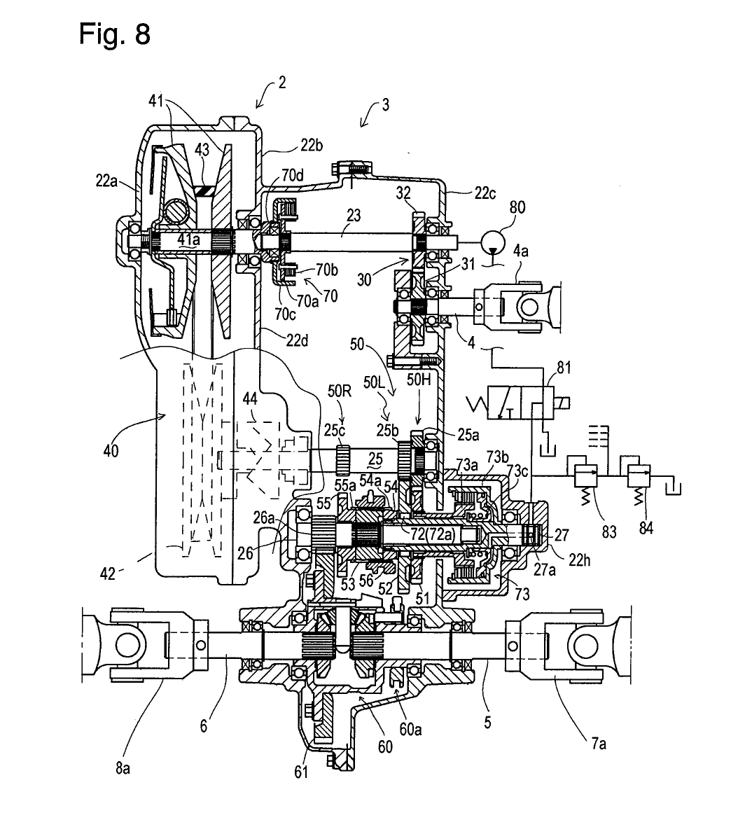

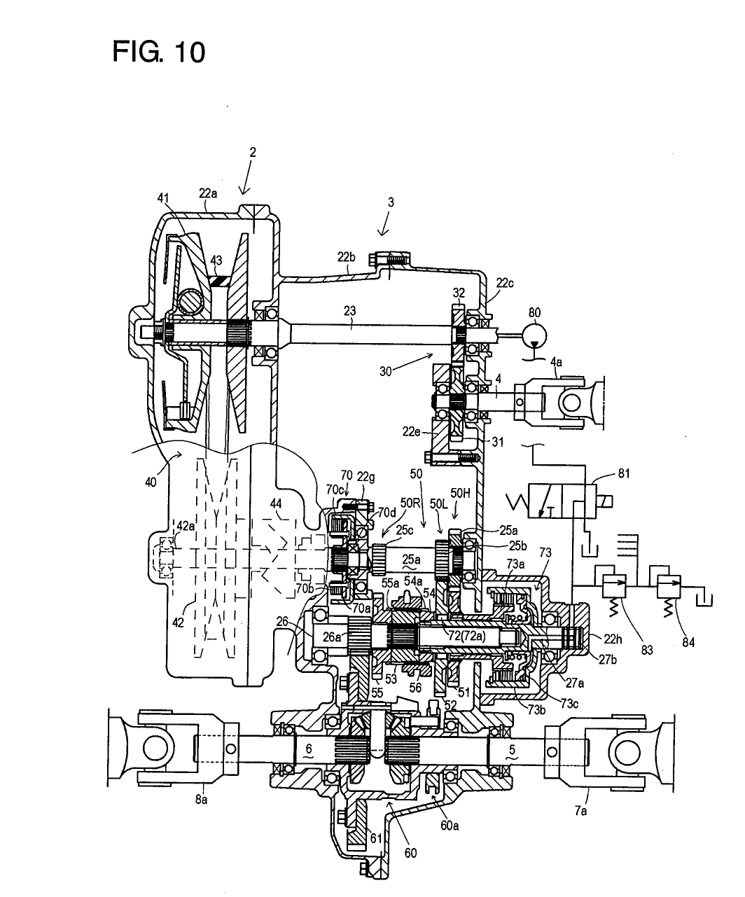

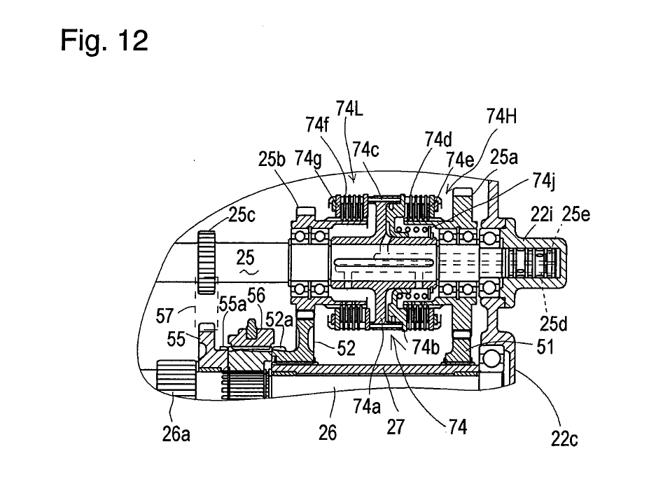

Further, each of FIGS. 8 and 10 illustrates hydraulic pump 80 for supplying fluid to a later-discussed hydraulic high-speed forward-traveling clutch 73, however, it does not show a gear train (including gear 33 disposed on main drive shaft 23) interposed between main drive shaft 23 and hydraulic pump 80. Alternatively, each of the third and fourth power transmission apparatuses may be provided with such a gear train for driving hydraulic pump 80. Referring to FIGS. 12, 13, 19 and 20, each of the sixth, seventh, tenth and eleventh power transmission apparatuses including respective hydraulic clutches 74, 75 and 78 may be provided with hydraulic pump 80 for supplying fluid to the hydraulic clutch, and may be provided with a gear train interposed between main drive shaft 23 and hydraulic pump 80. Alternatively, each of these power transmission apparatuses including respective hydraulic clutches may be provided with hydraulic pump 80 for supplying fluid to a hydraulically controlled implement other than the hydraulic clutch, and may be supplied with fluid for the hydraulic clutch from a hydraulic pressure source other than hydraulic pump 80.

Even if the power transmission apparatus, e.g., the first power transmission apparatus, includes no hydraulic clutch, the power transmission apparatus may be provided with hydraulic pump 80 so as to supply fluid to a hydraulically-controlled implement disposed outside the power transmission apparatus.

As shown in representative FIG. 3, CVT 40 including an input pulley 41, an output pulley 42 and a V-belt 43 is disposed in CVT casing 2. Input pulley 41 serving as a first shaft of CVT 40 is drivingly connected to main drive shaft 23. Output pulley 42 serving as a second shaft of CVT 40 is drivingly connected to a later-discussed gearshift drive shaft 25 of gear transmission 50 serving as the sub-transmission. Belt 43 is interposed between pulleys 41 and 42. A torque cam 44 for detecting road-load (applied onto either output shaft 5 or 6, i.e., axles 12 or 18) is interposed between output pulley 42 and gearshift drive shaft 25, so as to transmit the output power of CVT 40 to gearshift drive shaft 25 in correspondence to the road-load.

Input pulley 41 is a split pulley whose belt-groove has a variable width changed according to the centrifugal force caused according to the rotary speed of main drive shaft 23 serving as a drive shaft of CVT 40, i.e., according to the output rotary speed of prime mover 1. As the width of belt-groove of input pulley 41 changes, belt 43 shifts so as to change the pulley radius ratio between input pulley 41 and output pulley 42. As the rotary speed of main drive shaft 23 is reduced, the width of belt-groove of input pulley 41 is increased so as to reduce the ratio of input rotary speed to output rotary speed. However, the present power transmission apparatus is configured so that, even when the rotary speed of prime mover 1 exists in its idle rotary speed range, the speed ratio between pulleys 41 and 42 is more than zero (e.g., 0.75), i.e., a tension of belt 43 is ensured so as to prevent CVT 40 from being put into its neutral state, whereby a little driving force is transmitted to output pulley 42 so as to prevent belt 43 from slipping, i.e., to prolong the life of belt 43.

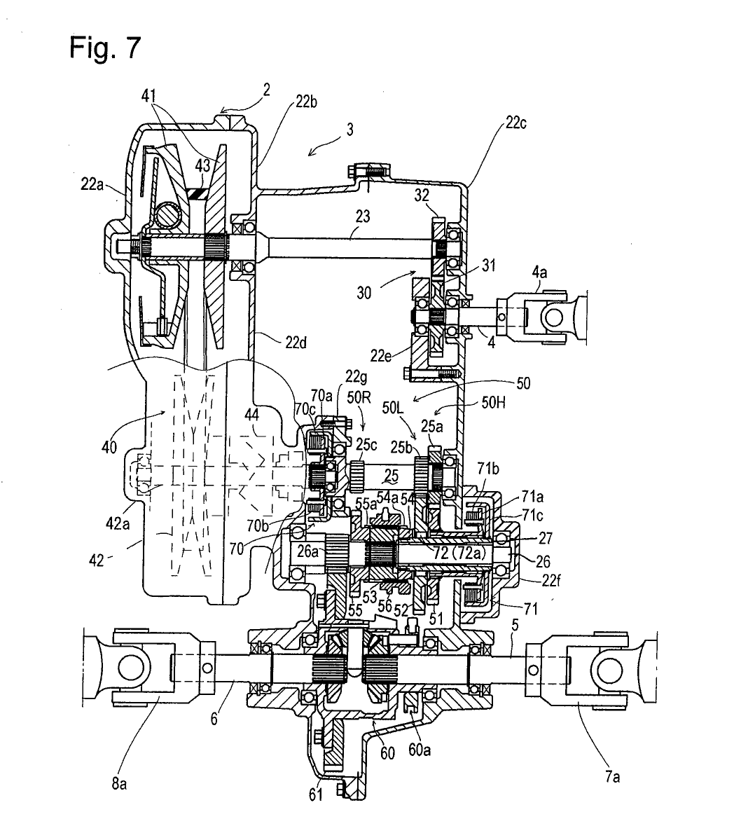

Meanwhile, as shown in representative FIGS. 3 and 7, a centrifugal clutch 70 is disposed on the upstream side of gear transmission 50 so as to ensure the neutral state of CVT 40 when prime mover 1 idles. In each of the first, third and eighth power transmission apparatuses shown in FIGS. 3, 8 and 15, a fore-and-aft horizontal pulley shaft 41a is journalled in CVT casing 2 so as to serve as a rotary shaft of input pulley 41. A rear end portion of pulley shaft 41a projects rearward from partition wall 22d into gear transmission casing 3. Centrifugal clutch 70 is interposed between the rear end of pulley shaft 41 and a front end of main drive shaft 23. In other words, centrifugal clutch 70 is interposed between prime mover 1 and CVT 40. Gearshift drive shaft 25 on which centrifugal clutch 70 is not provided is extended forward through partition wall 22d and journalled in CVT casing 2 so as to serve as a pulley shaft of output pulley 42.

In each of the second, fourth and ninth power transmission apparatuses shown in FIGS. 7, 10 and 18, centrifugal clutch 70 is interposed between CVT 40 and gear transmission 50. A fore-and-aft horizontal pulley shaft 42a is journalled in CVT casing 2 so as to serve as a rotary shaft of output pulley 42. Pulley shaft 42a projects at a rear end thereof rearward from partition wall 22d into gear transmission casing 3. A gearshift drive shaft 25 is journalled at a front end thereof through a bearing by a bearing wall 22g formed in gear transmission casing 3. Centrifugal clutch 70 is interposed between the rear end of pulley shaft 42a and the front end of gearshift drive shaft 25. Main drive shaft 23 on which centrifugal clutch 70 is not provided is extended forward through partition wall 22d and journalled in CVT casing 2 so as to serve as a pulley shaft of input pulley 41.

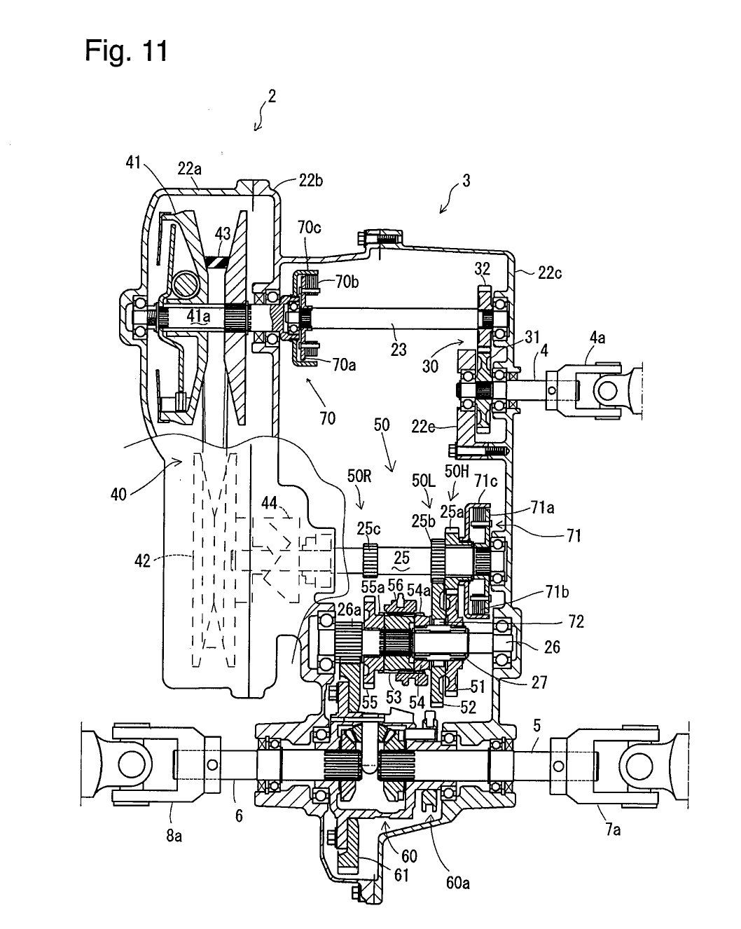

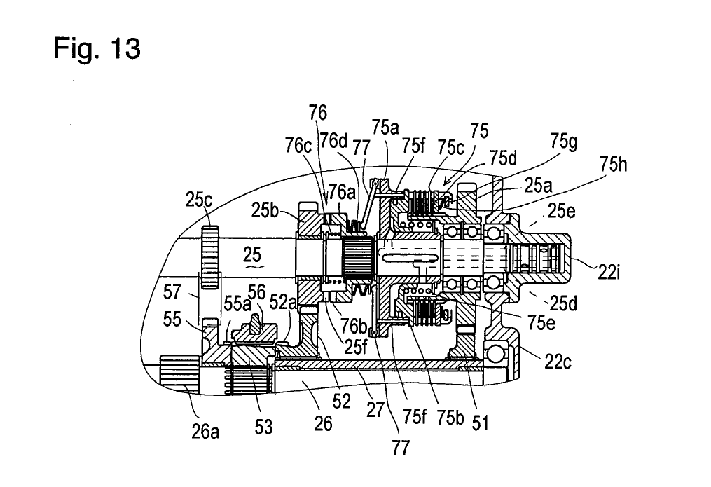

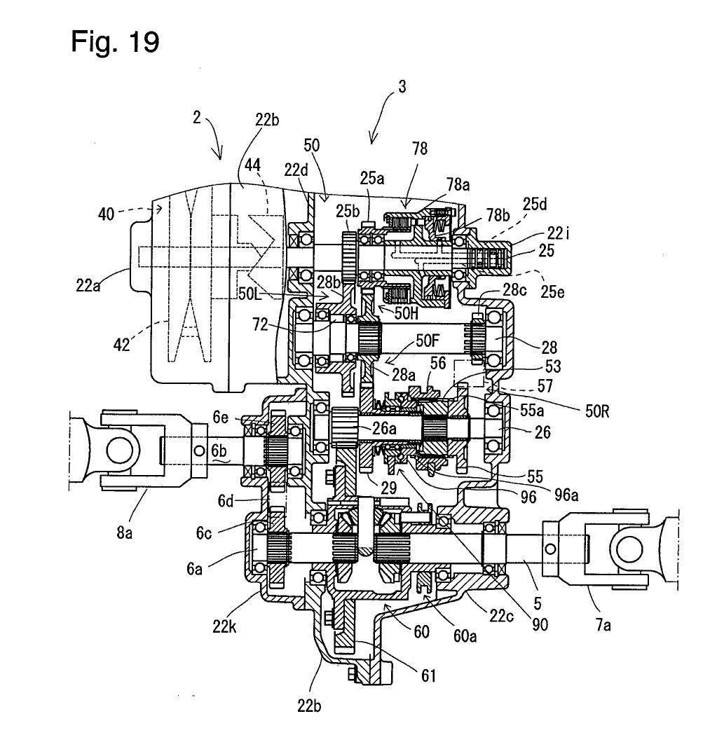

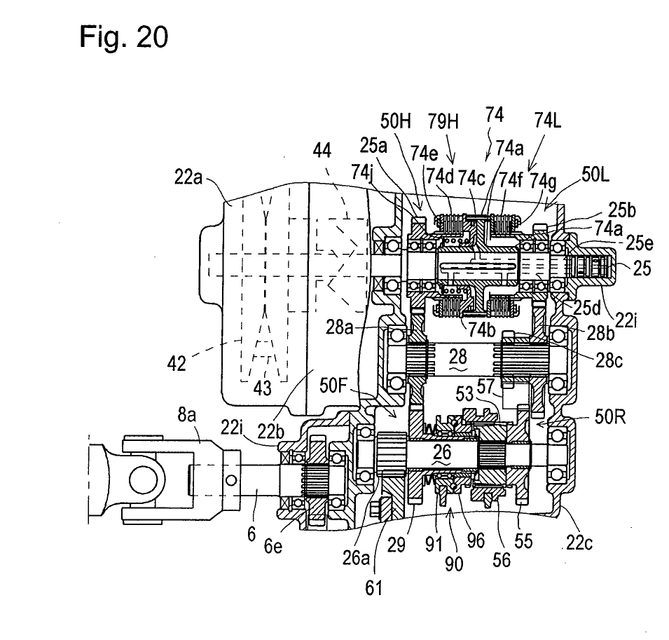

In the fifth power transmission apparatus shown in FIG. 11, similar to the first power transmission apparatus of FIG. 3, centrifugal clutch 70 is interposed between CVT 40 and main drive shaft 23, and gearshift drive shaft 25 serves as a pulley shaft of output pulley 42. With respect to the tenth and eleventh power transmission apparatuses, each of FIGS. 19 and 20 illustrates gearshift drive shaft 25 extended so as to serve as the pulley shaft of output pulley 42. As a result, each of the tenth and eleventh power transmission apparatus includes centrifugal clutch 70 interposed between CVT 40 (i.e., pulley shaft 41a of input pulley 41) and main drive shaft 23, similar to the first power transmission apparatus of FIG. 3, however, centrifugal clutch 70 is omitted in each of FIGS. 19 and 20. Alternatively, each of the tenth and eleventh power transmission apparatuses may be modified so as to have centrifugal clutch 70 interposed between pulley shaft 42a of output pulley 42 and gearshift drive shaft 25, similar to the second power transmission apparatus of FIG. 7. Further, although CVT 40 is not shown in each of FIGS. 12 and 13, each of the sixth and seventh power transmission apparatus may be provided with centrifugal clutch 70 disposed between CVT 40 and gearshift drive shaft 25 or on the upstream side of CVT 40.

Centrifugal clutch 70 includes a drive rotor 70a and a driven rotor 70c. A weight 70b is provided on drive rotor 70a. As the rotary speed of drive rotor 70a disposed on the upstream side of clutch 70 is increased, weight 70b is centrifugally opened by the centrifugal force so as to be pressed against driven rotor 70c, thereby engaging centrifugal clutch 70. To ensure the neutral state of the power transmission apparatus during idling of prime mover 1, centrifugal clutch 70 is set so that the maximum idle rotary speed of prime mover 1 is defined as the threshold rotary speed of prime mover 1 for switching centrifugal clutch 70.

With respect to centrifugal clutch 70 disposed on the upstream side of CVT 40, drive rotor 70a is fixed on main drive shaft 23, and driven rotor 70c is fixed on pulley shaft 41a. When centrifugal clutch 70 is disengaged, CVT 40 and a drive train downstream from CVT 40 are set into a neutral state. With respect to centrifugal clutch 70 disposed on the downstream side of CVT 40, drive rotor 70a is fixed on pulley shaft 42a, and driven rotor 70c is fixed on gearshift drive shaft 25. When centrifugal clutch 70 is disengaged, gear transmission 50 and a drive train downstream from gear transmission 50 are set into a neutral state while CVT 40 is ready to be driven by prime mover 1.

Centrifugal clutch 70 is provided with an overrunning clutch 70d for transmitting power bypassing centrifugal clutch 70, whether centrifugal clutch 70 is disposed on the upstream side or downstream side of CVT 40. Overrunning clutch 70d of centrifugal clutch 70 disposed on the upstream side of CVT 40 is interposed between pulley shaft 41 a and main drive shaft 23. Overrunning clutch 70d of centrifugal clutch 70 disposed on the downstream side of CVT 40 is interposed between pulley shaft 42a and gearshift drive shaft 25. When the vehicle descends a slope, the rotary speed of the driven (downstream) side of overrunning clutch 70 exceeds the rotary speed of the drive (upstream) side of overrunning clutch 70, that is, pulley shaft 41a rotates faster than main drive shaft 23, or gearshift drive shaft 25 rotates faster than pulley shaft 42a. At this time, overrunning clutch 70d is engaged so as to transmit power bypassing centrifugal clutch 70 backward from gear transmission 50 to prime mover 1 through CVT 40, thereby effectively applying an engine brake.

In the first power transmission apparatus shown in FIG. 3 representing all the power transmission apparatuses in the present application, gear transmission casing 3 incorporates a power train between input shaft 4 and the input means of CVT 40 (including main drive shaft 23 and regulation gear train 30). Further, gear transmission casing 3 incorporates gear transmission 50 serving as the sub-transmission driven by CVT 40, and incorporates a center differential gear unit 60 which is driven by gear transmission 50 and differentially connects front and rear output shafts 5 and 6 to each other. Center differential gear unit 60 is provided with a differential locking mechanism 60a.

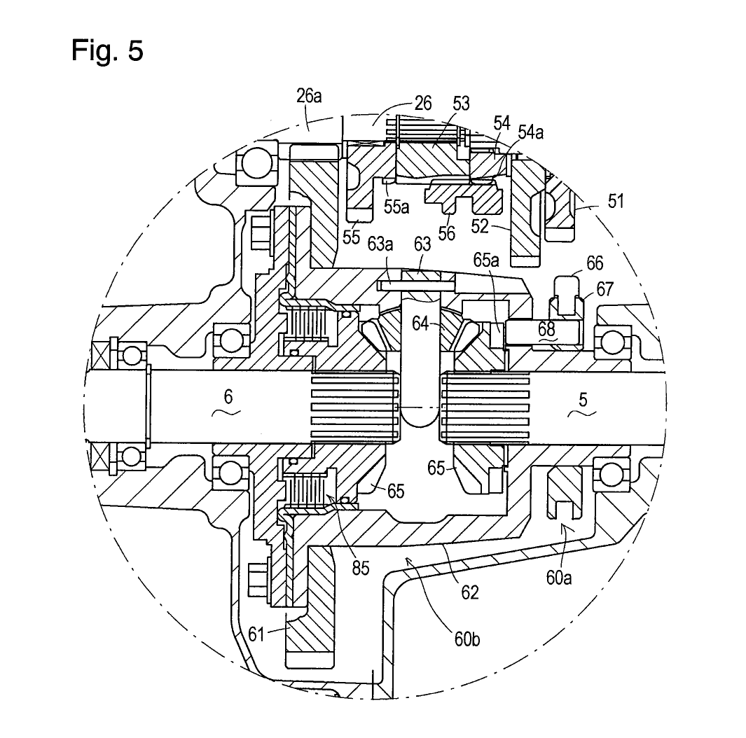

Center differential gear unit 60 contained in gear transmission casing 3 will be described with reference to FIG. 5. Incidentally, FIG. 5 illustrates an alternative limited slip center differential gear unit 60b. However, center differential gear unit 60b in FIG. 5 will now be referred to as center differential gear unit 60 so as to describe a common structure of center differential gear unit 60b shared with center differential gear unit 60 illustrated in representative FIG. 3.

Gear transmission 50 includes a gearshift driven shaft 26, on which a final pinion 26a is fixed (or integrally formed). Center differential gear unit 60 includes a differential cage 62, on which a bull gear 61 is fixed and meshes with final pinion 26a. A front end portion of rear output shaft 5 and a rear end portion of front output shaft 6 are relatively rotatably inserted into differential cage 62. In differential cage 62, a pair of differential side gears 65 are fixed on respective output shafts 5 and 6. A pinion shaft 63 is disposed perpendicular to output shafts 5 and 6, and engaged into differential cage 62 through an engaging pin 63a. In differential cage 62, a differential pinion 64 is relatively rotatably fitted on pinion shaft 63 and meshes with both front and rear differential side gears 65.

Center differential gear unit 60 is provided with differential locking mechanism 60a including a shifter 67, a fork 66 and a lock pin 68. Differential cage 62 is extended in the fore-and-aft direction of the vehicle, and shifter 67 is axially slidably fitted on one of front and rear end potions (in this embodiment, a rear end portion) of differential cage 62. Fork 66 is fitted to shifter 67 and operable from the outside of gear transmission casing 3. Lock pin 68 is fixed to shifter 67. One of differential side gears 65 (in this embodiment, rear differential side gear 65) is formed with a recess 65a, into which lock pin 68 slidably passed through differential cage 62 is adapted to be fitted.

In the representative first power transmission apparatus shown in FIG. 3, bull gear 61 is fixed on the front end of differential cage 62 so as to mesh with final pinion 26a fixed on a front portion of gearshift driven shaft 26, and differential locking mechanism 60a is disposed at the rear portion of center differential gear unit 60 so that lock pin 68 of shifter 67 fitted on the rear end of differential cage 62 is adapted to be fitted into rear differential side gear 65. In the representative eighth power transmission apparatus shown in FIG. 15, bull gear 61 is fixed on the rear end of differential cage 62 so as to mesh with final pinion 26a fixed on a rear portion of gearshift driven shaft 26, and differential locking mechanism 60a is disposed at the front portion of center differential gear unit 60 so that lock pin 68 of shifter 67 fitted on the front end of differential cage 62 is adapted to be fitted into front differential side gear 65. In this way, positions of bull gear 61 and differential locking mechanism 60a relative to differential cage 62 of center differential gear unit 60 can be determined in correspondence to the fore-and-aft position of final pinion 26a or another element.

When shifter 67 is disposed at a differential locking position, lock pin 68 is fitted into recess 65a so as to lock corresponding differential side gear 65 (in this embodiment, rear differential side gear 65) to differential cage 62. Differential side gear 65 locked with differential cage 62 locks the other differential side gear 65 to differential cage 62 through differential pinion 64. Consequently, rear output shaft 5 and front output shaft 6 are not-differentially connected to each other. When shifter 67 is disposed at a differential position, lock pin 68 is removed from recess 65a so as to be rotatable relative to differential cage 62, thereby allowing the differential rotation of output shafts 5 and 6.

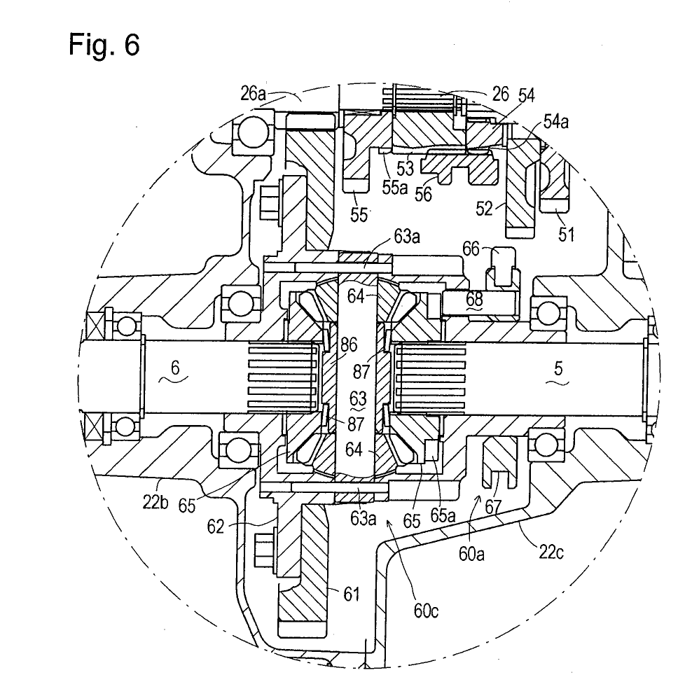

Description of the common structure shared among center differential gear unit 60 shown in representative FIG. 3, limited slip center differential gear unit 60b shown in FIG. 5 and another limited slip center differential gear unit 60c shown in FIG. 6 is concluded.

A peculiar structure of limited slip center differential gear unit 60b shown in FIG. 5 will now be described. In center differential gear unit 60b, a viscous coupling 85 is interposed between differential cage 62 and one differential side gear 65 (in this embodiment, front differential side gear 65) which is not adapted to fit lock pin 68 of differential locking mechanism 60a. With respect to viscous coupling 85, silicon oil is filled in a space between differential cage 62 and corresponding differential side gear 65, and disks fitted to differential side gear 65 and disks fitted to differential cage 62 are alternately aligned in the space. The silicon oil causes a shearing resistance between the neighboring disks so as to resist the rotation of differential side gear 65 relative to differential cage 62, thereby restricting the differential rotation of rear and front output shafts 5 and 6.

A peculiar structure of limited slip center differential gear unit 60c shown in FIG. 6 will now be described. In center differential gear unit 60c, pinion shaft 63 is engaged at opposite ends thereof to differential cage 62 (through respective engaging pins 63a), and a pair of differential pinions 64 are relatively rotatably fitted on pinion shaft 63 and disposed symmetrically with respect to the center axis of output shaft 5 or 6 when viewed in the axial direction of output shafts 5 and 6. A pressure member 86 is fitted on pinion shaft 63 between opposite differential pinions 64. A pair of disk springs 87 are interposed between pressure member 86 and respective differential side gears 65. In this way, pinion shaft 63 has a thrust (axial) resistance against differential side gears 65 so as to resist the rotation of output shafts 5 and 6 relative to differential cage 62, thereby restricting the differential rotation of output shafts 5 and 6.

Each of limited slip differential gear units 60b and 60c may be defined as any of center differential gear units 60 shown in FIG. 3 and other drawings or any of unshown center differential gear units adapted to the present power transmission apparatus.

Hereinafter, various arrangements of gear transmission 50 disposed in the first to eleventh power transmission apparatuses will be described with reference to FIGS. 3 to 21. As shown in representative FIG. 3, all disclosed gear transmissions 50 have a common structure such that, in gear transmission casing 3, a high-speed drive gear 25a and a low-speed drive gear 25b are provided on fore-and-aft gearshift drive shaft 25, high-speed drive gear 25a meshes with a high-speed driven gear so as to constitute a high-speed gear train 50H, and low-speed drive gear 25b meshes with a low-speed driven gear so as to constitute a low-speed gear train 50L.

In gear transmission 50 of each of the first to eleventh power transmission apparatuses, a high-speed clutch 71, 73, 74H, 75 or 78 and a low-speed clutch 72, 74L or 76 are contradictorily engaged and disengaged so as to drivingly connect one of high-speed gear train 50H and low-speed gear train 50L to gearshift driven shaft 26.

In each of the first to seventh power transmission apparatuses shown in FIGS. 3 to 14, high-speed clutch 71, 73, 74H or 75 is controlled to be engaged or disengaged based on detection of an input rotary speed of gear transmission 50 (i.e., the rotary speed of gearshift drive shaft 25), thereby disengaging or engaging low-speed clutch 72, 74L or 76 contradictorily to the high-speed clutch, whereby gear transmission 50 automatically gearshifts between a high speed stage and a low speed stage.

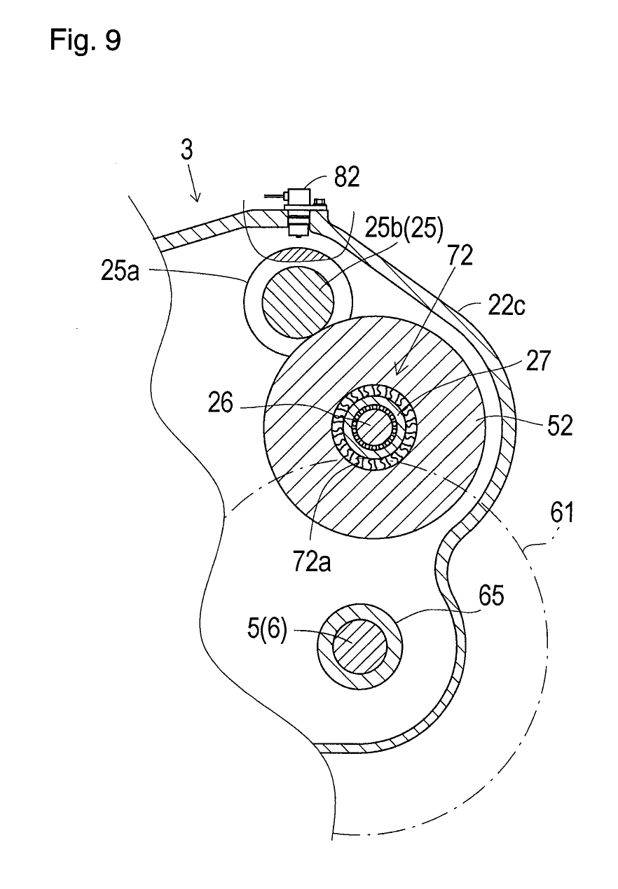

With respect to the detection of input rotary speed, in each of the first, second and fifth power transmission apparatuses shown in FIGS. 3, 7 and 11, centrifugal high-speed clutch 71 is mechanically engaged by a centrifugal force caused according to increase of rotary speed of gearshift drive shaft 25. In each of the third, fourth, sixth and seventh power transmission apparatuses shown in FIGS. 8, 10, 12 and 13, hydraulic high-speed clutch 73, 74H or 75 is electrically controlled to be engaged or disengaged based on detection of rotary speed of gearshift drive shaft 25 with a rotary speed sensor 82 shown in FIG. 9.

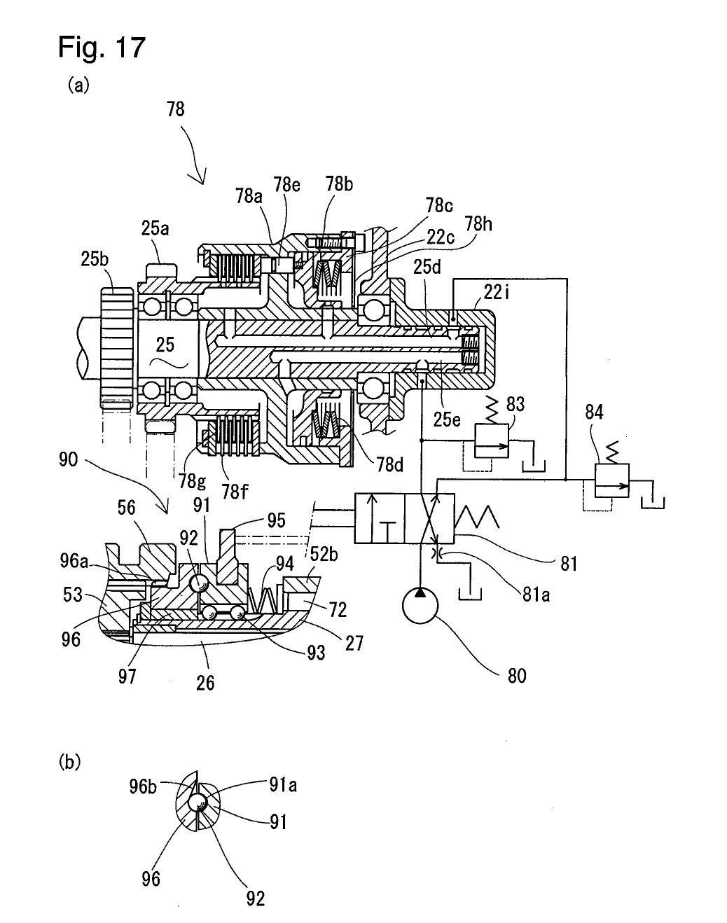

In each of the eighth to eleventh power transmission apparatuses shown in FIGS. 16 to 21, high-speed clutch 78 or 74H is controlled to be engaged or disengaged based on detection of a road-load (torque) applied onto output shaft 5 or 6 with a torque sensor 90 as best shown in FIG. 17, thereby disengaging or engaging low-speed clutch 72 or 74L contradictorily to the high-speed clutch, whereby gear transmission 50 automatically gearshifts between a high speed stage and a low speed stage.

In each of the first to ninth power transmission apparatuses (other than the tenth and eleventh power transmission apparatuses shown in FIGS. 19 and 20), a backward-traveling drive gear 25c is provided on gearshift drive shaft 25, and meshes with a backward-traveling driven gear 55 through an unshown idle gear so as to constitute a backward-traveling gear train 50R. Accordingly, high-speed gear train 50H and low-speed gear train 50L are provided for forward traveling of the vehicle, so that one of high-speed forward-traveling gear train 50H, low-speed forward-traveling gear train 50L and backward-traveling gear train 50R is selected so as to transmit the rotation of gearshift drive shaft 25 to gearshift driven shaft 26 on which final pinion 26a is provided to mesh with bull gear 61 of center differential gear unit 60.

Further, in each of the first to ninth power transmission apparatuses, as shown in representative FIG. 3, a cylindrical hollow forward-traveling driven shaft 27 is relatively rotatably fitted on gearshift driven shaft 26. A high-speed forward-traveling driven gear 51 and a low-speed forward-traveling driven gear 52 are provided on forward-traveling driven shaft 27. High-speed forward-traveling driven gear 51 meshes with high-speed forward-traveling drive gear 25a so as to constitute high-speed forward-traveling gear train 50H. Low-speed forward-traveling driven gear 52 meshes with low-speed forward-traveling drive gear 25b so as to constitute low-speed forward-traveling gear train 50L. Backward-traveling driven gear 55 is provided on gearshift driven shaft 26 outward of forward-traveling driven shaft 27.

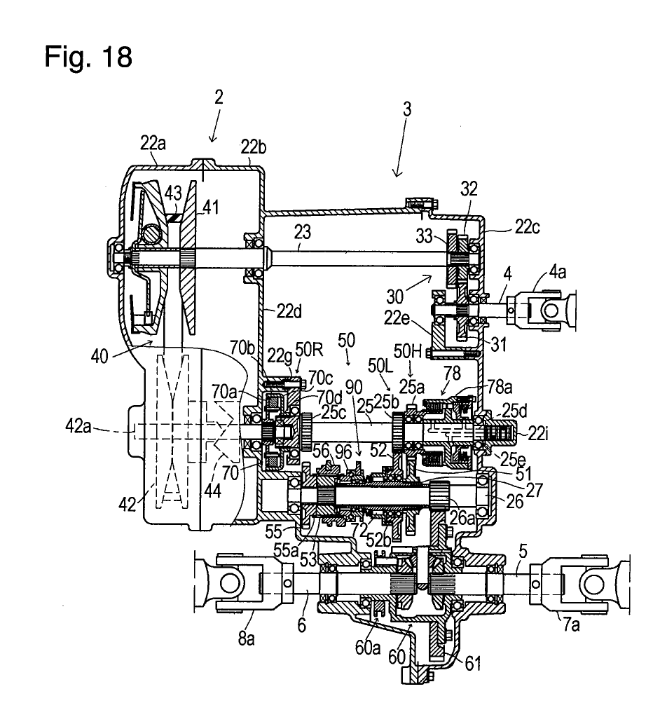

In each of the tenth power transmission apparatus shown in FIG. 18 and the eleventh power transmission apparatus shown in FIG. 19, a counter shaft 28 is disposed in parallel to gearshift drive shaft 25 and gearshift driven shaft 26 in gear transmission casing 3. High-speed gear train 50H and low-speed gear train 50L are interposed between gearshift drive shaft 25 and counter shaft 28, and a forward-traveling gear train 50F and backward-traveling gear train 50R are interposed between counter shaft 28 and gearshift driven shaft 26. Therefore, a speed level of gear transmission 50 can be selected between high and low speed levels whether the vehicle travels forward or backward.

More specifically, in each of the tenth and eleventh power transmission apparatuses, a high-speed driven gear 28a, a low-speed driven gear 28b and a backward-traveling drive gear 28c are provided on counter shaft 28. High-speed driven gear 28a meshes with high-speed drive gear 25a so as to constitute high-speed gear train 50H. Low-speed driven gear 28b meshes with low-speed drive gear 25b so as to constitute low-speed gear train 50L. A forward-traveling driven gear 29 and backward-traveling driven gear 55 are provided on gearshift driven shaft 26. Forward-traveling driven gear 29 meshes with high-speed driven gear 28a (serving as forward-traveling drive gear 28a) so as to constitute forward-traveling gear train 50H. Backward-traveling driven gear 55 meshes with backward-traveling drive gear 28c through an idle gear 57.

Hereinafter, each gear relatively rotatably provided on a shaft is fitted on the shaft through a bearing or a clutch, or slidably rotatably fitted on the shaft. Each gear relatively unrotatably provided on a shaft is a separate wheel from the shaft and fixed on the shaft (by spline-fitting), or is formed integrally with the shaft.

With respect to high-speed drive gear 25a, high-speed gear 25a in each of the first to fourth power transmission apparatuses shown in FIGS. 3 and 7 to 10 is relatively unrotatably provided on gearshift drive shaft 25 because clutch 71 or 73 for high-speed forward-traveling gear train 50H is interposed between high-speed driven gear 51 and forward-traveling driven shaft 27 on gearshift driven shaft 26. High-speed gear 25a in each of the fifth to eleventh power transmission apparatuses shown in FIGS. 11 to 13, 15 and 18 to 20 is relatively rotatably provided on gearshift drive shaft 25 because clutch 71, 74H, 75 or 78 for high-speed gear train 50H is interposed between high-speed drive gear 25a and gearshift drive shaft 25.

Low-speed drive gear 25b in each of the sixth, seventh and eleventh power transmission apparatuses shown in FIGS. 12, 13 and 20 is relatively rotatably provided on gearshift drive shaft 25 because clutch 74L or 76 for low-speed gear train 50L is interposed between low-speed drive gear 25b and gearshift drive shaft 25. Low-speed drive gear 25b in each of the other power transmission apparatuses is relatively unrotatably provided on gearshift drive shaft 25 because clutch 72 for low-speed gear train 50L is interposed between low-speed driven gear 52 and forward-traveling driven shaft 27 as shown in representative FIG. 3, or between low-speed driven gear 28b and counter shaft 28 as shown in FIG. 19.

In each of the first to eleventh power transmission apparatuses, as shown in representative FIG. 3, a clutch for backward-traveling gear train 50R, including a reverser shifter 56, is interposed between gearshift driven shaft 26 and backward-traveling driven gear 55 relatively rotatably provided on gearshift driven shaft 26. Thus, in each of the first to ninth power transmission apparatuses, as shown in representative FIG. 3, backward-traveling gear 25c is relatively unrotatably provided on gearshift drive shaft 25. In each of the tenth and eleventh power transmission apparatuses, as shown in FIGS. 19 and 20, backward-traveling drive gear 28c is relatively unrotatably provided on counter shaft 28.

In the first to ninth power transmission apparatuses, as shown in representative FIGS. 3 and 5, a spline hub 53 is fixed on gearshift driven shaft 26 just in front of forward-traveling driven shaft 27 relatively rotatably fitted on gearshift driven shaft 26. Backward-traveling driven gear 55 is relatively rotatably fitted on gearshift driven shaft 26 just in front of spline hub 53. Clutch teeth 55a are peripherally formed on a rear end of backward-traveling driven gear 55 facing spline hub 53.

In each of the tenth and eleventh power transmission apparatuses shown in FIGS. 19 and 20, forward-traveling driven gear 29 is relatively rotatably fitted on gearshift driven shaft 26. A center boss of forward-traveling driven gear 29 is cylindrically extended rearward around gearshift driven shaft 26. Spline hub 53 is fixed on gearshift driven shaft 26 just behind a rear end of the extended center boss of forward-traveling driven gear 29. Backward-traveling driven gear 55 is relatively rotatably fitted on gearshift driven shaft 26 just behind spline hub 53. Clutch teeth 55a are peripherally formed on a front end of backward-traveling driven gear 55 facing spline hub 53.

In each of the first to fifth power transmission apparatuses shown in FIGS. 3 to 11, as shown in respective FIGS. 3 and 5, a forward-traveling clutch member 54 is fixed on a front end of forward-traveling driven shaft 27 facing spline hub 53, and is peripherally formed with clutch teeth 54a on a front end portion thereof facing a rear end of spline hub 53.

In each of the sixth and seventh power transmission apparatuses shown in FIGS. 12 and 13, since high-speed forward-traveling drive gear 25a and low-speed forward-traveling drive gear 25b are connected to gearshift drive shaft 25 through the respective clutches, both high-speed forward-traveling driven gear 51 and low-speed forward-traveling driven gear 52 are relatively unrotatably provided on forward-traveling driven shaft 27. Low-speed forward-traveling driven gear 52 is disposed on a front end of forward-traveling driven shaft 27 and is peripherally formed with clutch teeth 52a on a front end portion thereof facing the rear end of spline hub 53.

In each of the eighth to eleventh power transmission apparatuses of FIGS. 15 to 20, a forward-traveling clutch member 96 serving as a component of torque sensor 90 is relatively rotatably fitted through a bearing 97 on forward-traveling driven shaft 27, as shown in FIG. 17(a), or the center boss of forward-traveling driven gear 29. Forward-traveling clutch member 96 is peripherally formed with clutch teeth 96a on an end portion thereof facing spline hub 53. In each of the eighth and ninth power transmission apparatuses, forward-traveling clutch member 96 has clutch teeth 96a on its front end. In each of the tenth and eleventh power transmission apparatuses, forward-traveling clutch member 96 has clutch teeth 96a on its rear end.

In each of the first to eleventh power transmission apparatuses, as shown in respective FIGS. 3, 12 and 15, a reverser shifter 56 is axially slidably and relatively unrotatably provided (spline-fitted) on spline hub 53, so as to be adapted to mesh with either backward-traveling clutch teeth 55a disposed on one side of spline hub 53 or forward-traveling clutch teeth 54a, 52a or 96a disposed on the other side of spline hub 53, thereby constituting a reverser clutch.

By manipulating a reverser operation device on the vehicle, reverser shifter 56 axially slides on reverser shifter 56, so as to be shifted among a neutral position, a forward-traveling position and a backward-traveling position. When reverser shifter 56 is disposed at the neutral position, reverser shifter 56 meshes with only spline hub 53, i.e., meshes with neither forward-traveling clutch teeth 54a, 52a or 96a nor backward-traveling clutch teeth 55a. When reverser shifter 56 is disposed at the forward-traveling position, reverser shifter 56 meshing with spline hub 53 meshes with forward-traveling clutch teeth 54a, 52a or 96a. When reverser shifter 56 is disposed at the backward-traveling position, reverser shifter 56 meshing with spline hub 53 meshes with backward-traveling clutch teeth 55a. Incidentally, in FIGS. 3, 15 and others, for convenience, a sectional view of reverser shifter 56 above gearshift driven shaft 26 is illustrated as reverser shifter 56 disposed at the neutral position, and a sectional view of reverser shifter 56 under gearshift driven shaft 26 is illustrated as reverser shifter 56 disposed at the forward-traveling position.

In each of the first to eleventh embodiments, final pinion 26a is relatively unrotatably provided on a suitable portion of gearshift driven shaft 26. In each of the eighth and ninth power transmission apparatuses shown in FIGS. 15 and 18, final pinion 26a is disposed adjacent to a rear end of gearshift driven shaft 26 (just behind forward-traveling driven shaft 27) so as to mesh with bull gear 61 fixed on the rear end of differential cage 62 of center differential gear unit 60 (with differential locking mechanism 60a disposed at the front portion of center differential gear unit 60). In each of the other power transmission apparatuses, final pinion 26a is disposed toward a front end of gearshift driven shaft 26 Oust in front of forward-traveling driven shaft 27 or forward-traveling driven gear 29) so as to mesh with bull gear 61 fixed on the front end of differential cage 62 of center differential gear unit 60 (with differential locking mechanism 60a disposed at the rear portion of center differential gear unit 60).

In gear transmission 50 of each of the first to ninth power transmission apparatuses shown in FIGS. 3 to 13 and 15 to 18, when reverser shifter 56 is disposed at the forward-traveling position, forward-traveling driven shaft 27 is relatively unrotatably engaged with gearshift driven shaft 26, and one of the high-speed and low-speed forward-traveling clutches is engaged and the other is disengaged so as to drivingly connect either high-speed forward-traveling gear train 50H (gears 25a and 51) or low-speed forward-traveling gear train 50L (gears 25b and 52) to forward-traveling driven shaft 27, thereby rotating gearshift driven shaft 26 in the direction for forward traveling of the vehicle. When reverser shifter 56 is disposed at the backward-traveling position, backward-traveling driven gear 55 is relatively unrotatably engaged with gearshift driven shaft 26 so as to transmit power from gearshift drive shaft 25 to gearshift driven shaft 26 through backward-traveling gear train 50R (gears 25c, 55, and the unshown idle counter gear), thereby rotating gearshift driven shaft 26 in the direction for backward traveling of the vehicle.

In gear transmission 50 of each of the tenth and eleventh power transmission apparatuses shown in FIGS. 19 and 20, one of the high-speed and low-speed clutches is engaged and the other is disengaged so as to drive counter shaft 28 through either high-speed gear train 50H (gears 25a and 28a) or low-speed gear train 50L (gears 25b and 28b). When reverser shift 56 is disposed at the forward-traveling position, forward-traveling driven gear 29 is relatively unrotatably engaged with gearshift driven shaft 26 so as to transmit the rotation of counter shaft 28 to gearshift driven shaft 26 through forward-traveling gear train 50F (gears 28a and 29), thereby rotating gearshift driven shaft 26 in the direction for forward traveling of the vehicle. When reverser shifter 56 is disposed at the backward-traveling position, backward-traveling driven gear 55 is relatively unrotatably engaged with gearshift driven shaft 26 so as to transmit the rotation of counter shaft 28 to gearshift driven shaft 26 through backward-traveling gear train 50R (gears 28c, 57 and 55), thereby rotating gearshift driven shaft 26 in the direction for backward traveling of the vehicle.

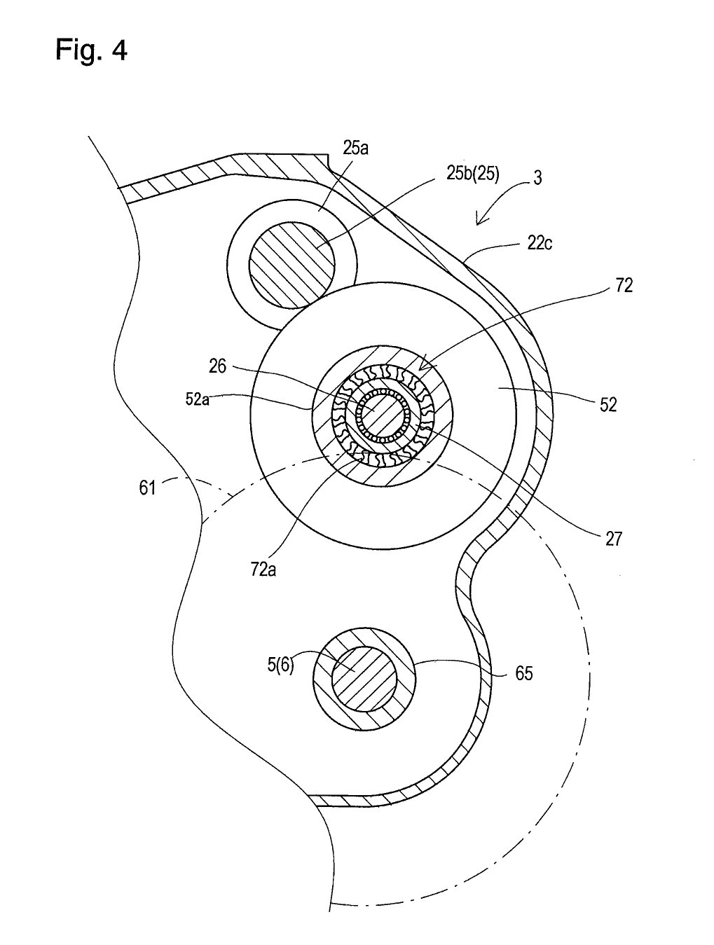

In each of the first to fifth, eighth and ninth power transmission apparatuses shown in FIGS. 3 to 11 and 15 to 18, low-speed forward-traveling driven gear 52 is fitted on forward-traveling driven shaft 27 through an overrunning clutch serving as low-speed forward-traveling clutch 72. As shown in FIG. 4 (illustrating the first, second, fifth, eighth and ninth power transmission apparatuses) and FIG. 9 (illustrating the third and fourth power transmission apparatuses), low-speed forward-traveling clutch 72 includes sprags 72a disposed radially around the center axis of gearshift driven shaft 26. When the rotary speed of forward-traveling driven shaft 27 on the downstream side of clutch 72 is reduced and becomes relatively lower than that of low-speed forward-traveling driven gear 52, sprags 72a rise to relatively unrotatably engage low-speed forward-traveling driven gear 52 to forward-traveling driven shaft 27.

In each of the first and second power transmission apparatuses, as shown in FIGS. 3 and 7, centrifugal high-speed forward-traveling clutch 71 is contained in a clutch casing 22f projecting rearward from a rear end surface of rear casing part 22c, so as to be interposed between high-speed forward-traveling driven gear 51 and forward-traveling driven shaft 27. Gearshift driven shaft 26 is journalled at a rear end thereof in clutch casing 22f through a bearing.

Centrifugal high-speed forward-traveling clutch 71 includes a drive rotor 71a and a driven rotor 71c. A weight 71b is provided on drive rotor 71a. As the rotary speed of drive rotor 71a disposed on the upstream side of clutch 71 is increased, weight 71b is centrifugally opened by the centrifugal force so as to be pressed against driven rotor 71c, thereby engaging clutch 71. Drive rotor 71a is fixed to high-speed forward-traveling driven gear 51 drivingly engaged with gearshift drive shaft 25 through high-speed forward-traveling drive gear 25a, and driven rotor 70c is fixed to forward-traveling driven shaft 27.

By adjusting the number of weights 71b or selecting one or more from weights 71b having different weights, or by another means, a threshold rotary speed of high-speed forward-traveling driven gear 51 for engaging or disengaging high-speed forward-traveling clutch 71 is set so that, when high-speed forward-traveling clutch 71 starts its disengaging action by reducing the rotary speed of high-speed forward-traveling driven gear 51, a rotary speed of forward-traveling driven shaft 27 reduced by the reduction of rotary speed of gear 51 reaches a value for starting the engaging action of low-speed forward traveling clutch 72.

It is assumed that reverser shifter 56 is disposed at the forward-traveling position for relatively unrotatably engaging forward-traveling driven shaft 27 to gearshift driven shaft 26. When the vehicle normally travels, centrifugal high-speed forward-traveling clutch 71 is engaged, and whereby low-speed forward-traveling cutch 72 is disengaged. Thus, high-speed forward-traveling gear train 50H is drivingly connected to forward-traveling driven shaft 27 so as to rotate gearshift driven shaft 26 at a high speed in the direction for forward traveling of the vehicle. When the vehicle starts or when the vehicle travels while receiving a heavy road-load (e.g., when the vehicle climbs a slope or when the vehicle is heavily load), the rotary speed of high-speed forward-traveling driven gear 51 (i.e., gearshift drive shaft 25) is lower than the threshold value, so that high-speed forward-traveling clutch 71 is disengaged, and whereby low-speed forward-traveling clutch 72 is engaged so as to drivingly connect low-speed forward-traveling gear train 50L to forward-traveling driven shaft 27, thereby rotating gearshift driven shaft 26 at a low speed in the direction for forward traveling of the vehicle.

As mentioned above, in the first power transmission apparatus of FIG. 3, centrifugal clutch 70 is disposed on the upstream side of CVT 40. In the second power transmission apparatus of FIG. 7, centrifugal clutch 70 is disposed on the downstream side of CVT 40, i.e., between CVT 40 and gear transmission 50.

In each of the third to fourth power transmission apparatuses shown in FIGS. 8 to 10, hydraulic high-speed forward-traveling clutch 73 is adapted to drivingly connect or separate high-speed forward-traveling driven gear 51 to and from forward-traveling driven shaft 27. A clutch casing 22h projects rearward from the rear end surface of rear casing part 22c so as to incorporate hydraulic high-speed forward-traveling clutch 73. Forward-traveling driven shaft 27 is journalled at the rear end thereof in clutch casing 22h through a bearing, and is formed therein with a fluid duct 27a opened to a fluid duct bored in a wall of clutch casing 22h.

In each of the third and fourth power transmission apparatuses, as shown in FIG. 8 and 10, a rear half of forward-traveling driven shaft 27 disposed in clutch casing 22h is solid (not hollow), and extended rearward from the rear end of gearshift driven shaft 26 so as to be formed therein with fluid duct 27a. In other words, only a front half of forward-traveling driven shaft 27 is hollow so as to relatively rotatably fit the rear end portion of gearshift driven shaft 26 therein.

Hydraulic high-speed forward-traveling clutch 73 includes a drive rotor 73a, a drum-shaped driven rotor 73b and a piston 73c. Drive rotor 73a is disposed on the upstream side of clutch 73 and extended forward so as to be relatively rotatably provided on forward-traveling driven shaft 27 and relative unrotatably engaged to high-speed forward-traveling driven gear 51. Driven rotor 73b is disposed on the downstream side of clutch 73 so as to be fixed on the rearward extended portion of forward-traveling driven shaft 27. Friction disks engaged to drive rotor 73a and friction disks engaged to driven rotor 73b are alternately aligned between drive rotor 73a and driven rotor 73b. Fluid duct 27a is opened to a fluid chamber in drive rotor 73a. Piston 73c is biased by a spring so as to separate the friction disks from one another. Fluid supplied into the fluid chamber in drive rotor 73a moves piston 73c against the spring so as to press the friction disks against one another. In this way, hydraulic high-speed forward-traveling clutch 73 is disengaged by releasing fluid from its fluid chamber, and engaged by fluid supplied into the fluid chamber.

Hydraulic pump 80 supplies fluid to the fluid chamber of high-speed forward-traveling clutch 73 through valve 81 disposed at a fluid-supplying position, the fluid duct bored in the wall of clutch casing 22h, and fluid duct 27a bored in forward-traveling driven shaft 27. A clutch fluid pressure regulation valve 83 regulates a pressure of fluid flowing from valve 81 to fluid duct 27a. Fluid released from valve 83 is supplied as lube to high-speed forward-traveling clutch 73. A lube pressure regulation valve 84 regulates a pressure of the lube.

An electromagnetic changeover valve 81 is switched between the fluid-supplying position and a fluid-releasing position by exciting and unexciting its solenoid. Valve 81 disposed at the fluid-supplying position supplies fluid to the fluid chamber of hydraulic high-speed forward-traveling clutch 73 from hydraulic pump 80 through fluid duct 27a. Valve 81 disposed at the fluid-releasing position releases fluid from the fluid chamber of hydraulic high-speed forward-traveling clutch 73 and hydraulic pump 80. As shown in FIG. 9, rotary speed sensor 82 is attached to gear transmission casing 3 (i.e., rear casing part 22c) so as to detect the rotary speed of gearshift drive shaft 25, and is electrically connected to a controller (not shown) for controlling the solenoid of valve 81.

When the controller recognizes that a rotary speed of gearshift drive shaft 25 detected by rotary speed sensor 82 is reduced to reach a threshold value for starting the engaging action of low-speed forward-traveling clutch 72, the controller shifts valve 81 to the fluid-releasing position so as to start the disengaging action of high-speed forward-traveling clutch 73.

It is assumed that reverser shifter 56 is disposed at the forward-traveling position for relatively unrotatably engaging forward-traveling driven shaft 27 to gearshift driven shaft 26. When the vehicle normally travels, electromagnetic changeover valve 81 is disposed at the fluid-supplying position so that hydraulic high-speed forward-traveling clutch 73 is supplied with fluid from hydraulic pump 81 and engaged, whereby low-speed forward-traveling cutch 72 is disengaged. Thus, high-speed forward-traveling gear train 50H is drivingly connected to forward-traveling driven shaft 27 so as to rotate gearshift driven shaft 26 at a high speed in the direction for forward traveling of the vehicle. When the vehicle starts or when the vehicle travels under a heavy road-load, the rotary speed of gearshift drive shaft 25 (i.e., high-speed forward-traveling driven gear 51) is lower than the threshold value, so that hydraulic high-speed forward-traveling clutch 73 is disengaged, whereby low-speed forward-traveling clutch 72 is engaged so as to drivingly connect low-speed forward-traveling gear train 50L to forward-traveling driven shaft 27, thereby rotating gearshift driven shaft 26 at a low speed in the direction for forward traveling of the vehicle.

As mentioned above, in the third power transmission apparatus of FIG. 8, centrifugal clutch 70 is disposed on the upstream side of CVT 40. In the fourth power transmission apparatus of FIG. 10, centrifugal clutch 70 is disposed on the downstream side of CVT 40, i.e., between CVT 40 and gear transmission 50.

In the fifth power transmission apparatus shown in FIG. 11, centrifugal high-speed forward-traveling clutch 71 is interposed between gearshift drive shaft 25 and high-speed forward-traveling drive gear 25a. In this regard, drive rotor 71a with weight 71b is fixed to gearshift drive shaft 25, and drum-shaped drive rotor 71c is fixed to high-speed forward-traveling drive gear 25a. When the rotary speed of gearshift drive shaft 25 is reduced and becomes lower than a certain rotary speed, high-speed forward-traveling clutch 71 is disengaged so as to separate high-speed forward-traveling gear train 50H from gearshift drive shaft 25.

With respect to the fifth power transmission apparatus, while low-speed forward-traveling clutch 72 is interposed between low-speed forward-traveling driven gear 52 and forward-traveling driven shaft 27, centrifugal high-speed forward-traveling clutch 71 may be replaced with a hydraulic clutch (see high-speed forward-traveling clutch 78 shown in representative FIG. 15) interposed between gearshift drive shaft 25 and high-speed forward-traveling drive gear 25a and switched based on detection of the rotary speed of gearshift drive shaft 25. Further, with respect to the fifth power transmission apparatus, although FIG. 11 illustrates centrifugal clutch 70 disposed between main drive shaft 23 and pulley shaft 41a (on the upstream side of CVT 40), centrifugal clutch 70 may be interposed between pulley shaft 42a and gearshift drive shaft 25 (between CVT 40 and gear transmission 50), similar to that shown in FIGS. 7 and 10.

In each of the sixth and seventh power transmission apparatuses shown in FIGS. 12 and 13, the high-speed forward-traveling clutch for high-speed forward-traveling gear train 50H and the low-speed forward-traveling clutch for low-speed forward-traveling gear train 50L are adapted to engage or disengage respective drive gears 25a and 25b to and from gearshift drive shaft 25. In the sixth power transmission apparatus shown in FIG. 12, both the high-speed and low-speed forward-traveling clutches are hydraulic clutches. In the seventh power transmission apparatus shown in FIG. 13, the high-speed forward-traveling clutch is a hydraulic clutch, and the low-speed forward-traveling clutch is a dog clutch.

In the sixth power transmission apparatus shown in FIG. 12, a hydraulic clutch device 74 including high-speed forward-traveling clutch 74H and low-speed forward-traveling clutch 74L is disposed on gearshift drive shaft 25. Gearshift drive shaft 25 is slidably rotatably supported at a rear end portion in a shaft casing 22i projecting rearward from the rear end surface of rear casing part 22c. In gear transmission casing 3 (rear casing part 22c), high-speed forward-traveling gear 25a and low-speed forward-traveling gear 25b are relatively rotatably fitted on gearshift drive shaft 25 through respective bearings. Hydraulic clutch device 74 includes a drive rotor 74a shared between clutches 74L and 74H. Drive rotor 74a has a center boss portion fixed on gearshift drive shaft 25 between gears 25a and 25b. Drive rotor 74a has a partition wall portion radially extended from a fore-and-aft intermediate portion of the center boss portion, and has a drum-shaped portion extended forward and rearward from the outer peripheral end of the partition wall portion. In this way, drive rotor 74a has a front fluid chamber in front of the partition wall between the center boss portion and the drum-shaped portion, and has a rear fluid chamber behind the partition wall between the center boss portion and the drum-shaped portion.

A front end portion of high-speed forward-traveling drive gear 25a is extended forward into the rear fluid chamber in drive rotor 74a. In the rear fluid chamber, friction disks 74d are fitted on the drum-shaped portion of drive rotor 74a, and friction disks 74e are fitted on the front end portion of high-speed forward-traveling drive gear 25a, so that friction disks 74d and friction disks 74e are alternately aligned, thereby constituting high-speed forward-traveling clutch 74H.

A rear end portion of low-speed forward-traveling drive gear 25b is extended rearward into the front fluid chamber in drive rotor 74a. In the front fluid chamber, friction disks 74f are fitted on the drum-shaped portion of drive rotor 74a, and friction disks 74g are fitted on the rear end portion of low-speed forward-traveling drive gear 25b, so that friction disks 74f and friction disks 74g are alternately aligned, thereby constituting low-speed forward-traveling clutch 74L.

In the rear fluid chamber of high-speed forward-traveling clutch 74H, a piston 74b is axially slidably disposed between the partition wall portion of drive rotor 74a and the foremost disk of friction disks 74d and 74e, and a spring 74j is disposed so as to bias piston 74b forward away from friction disks 74d and 74e, i.e., in the direction for disengaging high-speed forward-traveling clutch 74H.

A clutch fluid duct 25e is bored in gearshift drive shaft 25 and opened to a clutch fluid chamber in front of piston 74b in the rear fluid chamber through a fluid hole penetrating the center boss portion of drive rotor 74a. Fluid supplied into the clutch fluid chamber from clutch fluid duct 25e pushes piston 74b rearward toward friction disks 74d and 74e, so as to press friction disks 74d and 74e against one another, thereby engaging high-speed forward-traveling clutch 74H.

A connection pin 74c is extended forward from piston 74b and axially slidably passed through the drum-shaped portion of drive rotor 74a so as to face the group of friction disks 74f and 74g of low-speed forward-traveling clutch 74L. When fluid is drained from the clutch fluid chamber and piston 74b biased by spring 74j is disposed at its initial position, friction disks 74d and 74e are separated from one another so as to disengage high-speed forward-traveling clutch 74H. At this time, connection pin 74c is disposed at its foremost slide position, so as to press friction disks 74f and 74g against one another, thereby engaging low-speed forward-traveling clutch 74L.

When fluid is supplied into the clutch fluid chamber, piston 74b slides rearward so as to press friction disks 74d and 74e against one another, thereby engaging high-speed forward-traveling clutch 74H. Simultaneously, connection pin 74c slides rearward together with piston 74b so as to separate friction disks 74f and 74g from one another, thereby disengaging low-speed forward-traveling clutch 74L.

In this way, in hydraulic clutch device 74, high-speed forward-traveling clutch 74H and low-speed forward-traveling clutch 74L are contradictorily engaged and disengaged. For convenience, in FIG. 12, hydraulic clutch device 74, in which clutch 74H is disengaged and clutch 74L is engaged, is illustrated above gearshift drive shaft 25, and hydraulic clutch device 74, in which clutch 74H is engaged and clutch 74L is disengaged, is illustrated under gearshift drive shaft 25.

Clutch fluid duct 25e is extended axially in gearshift drive shaft 25, and opened at a rear end thereof in shaft casing 22i so as to be supplied with fluid from hydraulic pump 80 through electromagnetic changeover valve 81 and a fluid hole penetrating a wall of shaft casing 22i, similar to clutch fluid duct 27d formed in forward-traveling driven shaft 27 for clutch 73 in clutch casing 22h of each of the third and fourth power transmission apparatuses shown in FIGS. 8 to 10. As mentioned above, electromagnetic changeover valve 81 is switched between the fluid-supplying position and the fluid-releasing position based on the rotary speed of gearshift drive shaft 25 detected by rotary speed sensor 82. When valve 81 is disposed at the fluid-releasing position, in hydraulic clutch device 74, piston 74b is disposed at the initial position so that high-speed forward-traveling clutch 74H is disengaged and low-speed forward-traveling clutch 74L is engaged, thereby drivingly connecting low-speed forward-traveling gear train 50L to gearshift drive shaft 25. When valve 81 is disposed at the fluid-supplying position, in hydraulic clutch device 74, piston 74b is actuated so as to engage high-speed forward-traveling clutch 74H and to disengage low-speed forward-traveling clutch 74L, thereby drivingly connecting high-speed forward-traveling gear train 50H to gearshift drive shaft 25.

Gearshift drive shaft 25 is further axially bored with a lube duct 25d, which is extended in parallel to clutch fluid duct 25e and opened at the rear end thereof in shaft casing 22i. Clutch pressure regulation valve 83 as shown in FIGS. 8 and 10 releases excessive fluid into lube duct 25d so as to supply the fluid as lube to the friction disks of clutches 74H and 74L. Friction disks 74d and 74e are disposed in a rear lube chamber in the rear fluid chamber behind piston 74b, and friction disks 74f and 74g are disposed in a front lube chamber in the front fluid chamber. Lube duct 25d is opened through the hole penetrating the center boss of drive rotor 74a to the front and rear lube chambers.

In the seventh power transmission apparatus shown in FIG. 13, hydraulic high-speed forward-traveling clutch 75 interlocks with a dog-clutch type low-speed forward-traveling clutch 76. Shaft casing 22i supports gearshift drive shaft 25, and high-speed and low-speed forward-traveling drive gears 25a and 25b are relatively rotatably fitted on gearshift drive shaft 25, similar to the sixth power transmission apparatus shown in FIG. 12. High-speed forward-traveling clutch 75 includes a drive rotor 75a whose center boss portion is fixed on gearshift drive shaft 25 between gears 25a and 25b. A front end portion of drive rotor 75a is radially extended from a front end of the center boss portion. Drive rotor 75a includes a drum-shaped portion extended rearward from an outer peripheral end of the radially extended front portion thereof.

A front end portion of high-speed forward-traveling drive gear 25a is extended forward into a fluid chamber in drive rotor 75a between the center boss portion and the drum-shaped portion. In the fluid chamber, friction disks 75c are fitted to the drum-shaped portion of drive rotor 75a, and friction disks 75d are fitted into the front end portion of high-speed forward-traveling drive gear 25a, so that friction disks 75c and friction disks 75d are alternately aligned, thereby constituting high-speed forward-traveling clutch 75.

In the fluid chamber of high-speed forward-traveling clutch 75, a piston 75b is axially slidably disposed between the radially extended front end portion of drive rotor 75a and the foremost disk of friction disks 75c and 75d. Further, in the fluid chamber, a spring 75e is disposed so as to bias piston 75b forward away from friction disks 75c and 75d in the direction for disengaging forward-traveling high-speed clutch 75.

Clutch fluid duct 25e bored in gearshift drive shaft 25 is opened through a fluid hole penetrating the center boss portion of drive rotor 75 to a clutch fluid chamber in front of piston 75b in the fluid chamber. When the clutch fluid chamber is supplied with fluid from clutch fluid duct 25e, the fluid pushes piston 75b rearward against spring 75e so as to press friction disks 75c and 75d against one another, thereby engaging high-speed forward-traveling clutch 75.

A stopper 75g is fixed on a rear end of the drum-shaped portion of drive rotor 75a. A disk spring 75h is interposed between stopper 75g and the rearmost friction disk 75c (or 75d) of friction disks 75c and 75d, so as to bias friction disks 75c and 75d in the direction for pressing friction disks 75c and 75d against one another. When fluid is released from the clutch fluid chamber in front of piston 75b, pawls 76b and pawls 26f serving as the dog-clutch type low-speed forward-traveling clutch 76 mesh with each other. When pawls 76b mesh with pawls 26f, disk spring 75h prevents the pressure among friction disks 75c and 75d from being completely canceled, that is, friction disks 75c and 75d are pressed against one another by slightly friction pressure, thereby reducing the shock in meshing between pawls 76b and 26f.

A connection pin 75f is extended from piston 75b, and is axially slidably passed through the drum-shaped portion of drive rotor 75a. Connection pin 75f projects forward from the front end of drive rotor 75a so as to abut at a front end thereof against a pressure arm 77 pivoted on the front end peripheral portion of drive rotor 75a.

A clutch slider 76a is axially slidably spline-fitted on gearshift drive shaft 25 between low-speed forward-traveling drive gear 25b and drive rotor 75a. A front portion of clutch slider 76a is formed into a cylinder disposed around gearshift drive shaft 25, and formed at a front end thereof with pawls 76b adapted to mesh with pawls 25f formed on a rear end portion of low-speed forward-traveling drive gear 25b. In this way, clutch slider 76a and low-speed forward-traveling drive gear 25b constitute low-speed forward-traveling clutch 76.

A spring 76c is wound around gearshift drive shaft 25 in the cylindrical front portion of clutch slider 76a so as to bias clutch slider 76a rearward away from low-speed forward-traveling drive gear 25b. A rear portion of clutch slider 76a is formed into a boss spline-fitted on gearshift drive shaft 25. Clutch slider 76a is stepped between the cylindrical front portion and the rear boss portion so as to have a vertical surface. A disk spring 76d is provided on the rear boss portion of clutch slider 76a between the vertical surface and pressure arm 77, so as to absorb a shock caused when clutch slider 76a is engaged with low-speed forward-traveling drive gear 25b by the action of pressure arm 77.

When fluid is released from the clutch fluid chamber in high-speed forward-traveling clutch 75, piston 75b biased by spring 75e is disposed at its initial position so as to separate friction disks 75c and 75d from one another, thereby disengaging high-speed forward-traveling clutch 75. Simultaneously, connection pin 75f is disposed at its foremost slide position where pressure arm 77 is rotated forward to push clutch slider 76a forward against disk spring 76d so as to mesh pawls 76b with pawls 25f, thereby engaging low-speed forward-traveling clutch 76.

On the other hand, when fluid is supplied into the clutch fluid chamber of high-speed forward-traveling clutch 75, piston 75b slides rearward so as to press friction disks 75c and 75d against one another, thereby engaging high-speed forward-traveling clutch 75. Simultaneously, connection pin 75f slides rearward together with piston 75b, and clutch slider 76a slides rearward by the force of spring 76c so as to separate pawls 76b from pawls 25f, thereby disengaging low-speed forward-traveling clutch 76.

In this way, in the seventh power transmission apparatus shown in FIG. 13, high-speed forward-traveling clutch 75 and low-speed forward-traveling clutch 76 are contradictorily engaged and disengaged. For convenience, in FIG. 13, disengaged clutch 75 and engaged clutch 76 are illustrated above gearshift drive shaft 25, and engaged clutch 75 and disengaged clutch 76 are illustrated under gearshift drive shaft 25.

Similar to the sixth power transmission apparatus shown in FIG. 12, gearshift drive shaft 25 is formed with clutch fluid duct 25e for supplying fluid for actuating piston 75b of high-speed forward-traveling clutch 75 from hydraulic pump 80 through electromagnetic changeover valve 81 switched based on detection by rotary sensor 82, and gearshift drive shaft 25 is formed with lube duct 25d for supplying lube to high-speed forward-traveling clutch 75 from clutch fluid pressure regulation valve 83.

In this way, in each of the sixth and seventh power transmission apparatuses shown in FIGS. 12 and 13, the high-speed forward-traveling clutch and the low-speed forward-traveling clutch are connected to each other through a mechanical linkage so as to be contradictorily engaged and disengaged. Preferably, in each of the sixth and seventh power transmission apparatuses, centrifugal clutch 70 with overrunning clutch 70d is disposed on the upstream side of gear transmission 50, similar to that shown in FIG. 8 or 10.

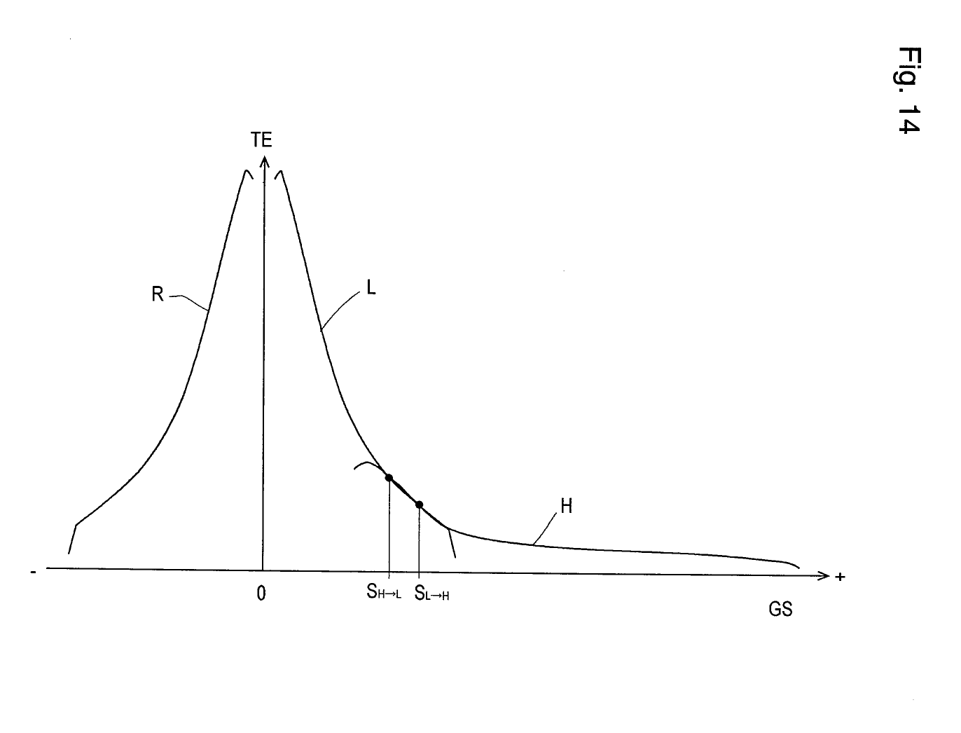

Referring to FIG. 14, description will be given of a driving performance, i.e., a relation of traction effort TE to ground speed GS by gear transmission 50 in each of the first to seventh power transmission apparatuses shown in FIGS. 3 to 13, which gearshifts gear transmission 50 based on detection of the input rotary speed of gear transmission 50.

In FIG. 14, ground speed GS during forward traveling of the vehicle is defined as a plus, and ground speed GS during backward traveling of the vehicle is defined as a minus. A graph L indicates a driving performance due to low-speed forward-traveling gear train 50L by engaging the low-speed forward-traveling clutch during forward traveling of the vehicle by setting reverser shifter 56 at the forward-traveling position. A graph H indicates a driving performance due to high-speed forward-traveling gear train 50H by engaging the high-speed forward-traveling clutch during forward traveling of the vehicle by setting reverser shifter 56 at the forward-traveling position.

When the vehicle starts (ground speed GS increases from 0), the high-speed forward-traveling clutch is disengaged and the low-speed forward-traveling clutch is engaged, so as to obtain high traction effort TE due to the driving of low-speed forward-traveling gear train 50L as indicated by graph L. As ground speed GS increases, traction effort TE due to the power of prime mover 1 decreases. When ground speed GS reaches a value SL→H, the high-speed forward-traveling clutch starts its engaging action (as indicated by graphs L and H).

A value SH→L of ground speed GS for disengaging the high-speed forward-traveling clutch for switching the speed stage of gear transmission 50 from the high speed stage to the low speed stage is smaller than value SL→H of ground speed GS for engaging the high-speed forward-traveling clutch for switching the speed stage of gear transmission 50 from the low speed stage to the high speed stage so as to establish a hysteresis range about gearshift of gear transmission 50, thereby preventing excessively frequent gearshift and ensuring a stable driving performance.

In this regard, while gear transmission 50 is set at the high speed stage (where the high-speed clutch is engaged and the low-speed clutch is disengaged), if ground speed GS is reduced and the reduced ground speed GS exists in the hysteresis range, the high speed stage is kept. That is, the speed stage is switched from the high speed stage to the low speed stage (where the high-speed clutch is disengaged and the low-speed clutch is engaged) only after ground speed GS becomes lower than the minimum value SH→L of the hysteresis range. On the other hand, while gear transmission 50 is set at the low speed stage, if ground speed GS is increased and the increased ground speed GS exists in the hysteresis range, the low speed stage is kept. That is, the speed stage is switched from the low speed stage to the high speed stage only after ground speed GS exceeds the maximum value SL→H of the hysteresis range.

Further, values SL→H and SH→L of ground speed GS (especially, SH→L) are set so that the minimum traction effort TE due to the driving of high-speed forward-traveling gear train 50H matches with a minimum traction effort for climbing a 30% ascending slope, whereby the vehicle can travel with the driving of high-speed forward-traveling gear train 50H unless a slope rate exceeds 30%.

Further, both values SL→H and SH→L are (i.e., higher SL→H is) lower than a half value of the maximum ground speed GS so as to make the high speed stage more frequent than the low speed stage, thereby ensuring an efficient main traveling of the vehicle due to the high speed stage.

Referring to a graph R, backward traveling gear train 50R is set so as to ensure high traction effort TE relative to ground speed GS during backward traveling of the vehicle, i.e., when reverser shifter 56 is disposed at the backward traveling position, whereby the ground speed range due to backward traveling gear train 50R is lower than that due to high-speed forward-traveling gear train 50H for the normal forward traveling of the vehicle (regardless of whether it is plus or minus in FIG. 14). For example, the characteristic of traction effort TE relative to ground speed GS during backward traveling of the vehicle is substantially equal to that during forward traveling of the vehicle with the driving of low-speed forward-traveling gear train 50L.

In each of the first to seventh power transmission apparatuses shown in FIGS. 3 to 13, sprags 72a of overrunning low-speed forward-traveling clutch 72 and weight 71b of centrifugal high-speed forward-traveling clutch 71 or a timing of electromagnetic changeover valve 81 relative to the rotary speed value detected by rotary speed sensor 82 for switching hydraulic high-speed forward-traveling clutch 73, 74H or 75 are adjusted so as to ensure the driving performance during forward traveling of the vehicle defined by graphs H and L in FIG. 14.

Especially, in each of the third, fourth, sixth and seventh power transmission apparatuses using electromagnetic changeover valve 81 for switching the high-speed forward-traveling clutch, a rotary speed value detected by rotary speed sensor 82 defined as threshold ground speed GS for disengaging the high-speed forward-traveling clutch (switching from the high speed stage to the low speed stage) is set smaller than that defined as threshold ground speed GS for engaging the high-speed forward-traveling clutch (switching from the low speed stage to the high speed stage) so as to ensure the hysteresis speed range. When the vehicle is accelerated and ground speed GS reaches value SL→H, valve 81 having been set at the fluid-supplying position is switched to the fluid-releasing position so as to engage high-speed forward-traveling clutch 73, 74H or 75. When the vehicle is decelerated and ground speed GS reaches value SH→L, valve 81 having been set at the fluid-releasing position is switched to the fluid-supplying position so as to disengage high-speed forward-traveling clutch 73, 74H or 75.

In each of the eighth and ninth power transmission apparatuses shown in FIGS. 15 to 18, hydraulic high-speed forward-traveling clutch 78 is provided around gearshift drive shaft 25 so as to be interposed between gearshift shaft 25 and high-speed forward-traveling drive gear 25a. A structure of high-speed forward-traveling clutch 78 will be described, mainly referring to FIG. 17(a). A drive rotor 78a of high-speed forward-traveling clutch 78 includes a center boss portion fixed on gearshift drive shaft 25. Drive rotor 78a includes a partition wall portion radially extended from a fore-and-aft intermediate portion of the center boss portion, and includes a drum-shaped portion extended forward and rearward from an outer peripheral end of the partition wall portion.

In drive rotor 78a, a front fluid chamber is disposed in front of the partition wall portion, and a rear fluid chamber is disposed behind the partition wall portion. A rear end portion of high-speed forward-traveling drive gear 25a is extended rearward into the front fluid chamber. In the front fluid chamber, friction disks 78f are fitted to the drum-shaped portion of drive rotor 78a, and friction disks 78g are fitted to the rear portion of high-speed forward-traveling drive gear 25a, so that friction disks 78f and friction disks 78g are alternately aligned. A piston 78b is axially slidably disposed in the rear fluid chamber. A stopper 78c is fixed on a rear end of the drum-shaped portion of drive rotor 78a so as to define the rearmost slide position of piston 78b. In the rear fluid chamber, a disk spring 78d is interposed between piston 78b and stopper 78c so as to bias piston 78b forward toward friction disks 78f and 78g.

A pressure pin 78e is axially slidably passed through the partition wall portion of drive rotor 78a so as to be interposed between piston 78b and the rearmost friction disk of the group of friction disks 78f and 78g, and is fixed to piston 78b. A clutch fluid chamber is formed in the rear fluid chamber between piston 78b and the partition wall portion of drive rotor 78a. When fluid is released from the clutch fluid chamber, piston 78b and pressure pin 78e fixed to piston 78b press friction disks 78f and 78g against one another due to the force of spring 78d, thereby engaging high-speed forward-traveling clutch 78.

Shaft casing 22i projects rearward from the rear end surface of rear casing part 22c. Gearshift drive shaft 25 projects rearward from the rear end surface of rear casing part 22c so as to be slidably rotatably supported at a rear end portion thereof in shaft casing 22i. Gearshift drive shaft 25 is axially bored therein with clutch fluid duct 25e opened through a hole penetrating the center boss portion of drive rotor 78a into the clutch fluid chamber in the rear fluid chamber in drive rotor 78a in front of piston 78b. Clutch fluid duct 25e is opened at a rear end thereof into shaft casing 22i so as to be connected to hydraulic pump 80 through a hole penetrating a wall of shaft casing 22i and a fluid passage constituted by a pipe or so on. Changeover valve 81 is disposed on the fluid passage between the hole of shaft casing 22i and hydraulic pump 80 so as to be switchable between the fluid-supplying position for supplying fluid from hydraulic pump 80 to the clutch fluid chamber of high-speed forward-traveling clutch 78 and the fluid-releasing position for draining fluid from the clutch fluid chamber and hydraulic pump 80.

Clutch fluid pressure regulation valve 83 regulates the pressure of fluid from changeover valve 81 to clutch fluid duct 25e. When changeover valve 81 is disposed at the fluid-releasing position, fluid released from the clutch fluid chamber is passed through changeover valve 81 and an orifice 81a, so as to moderate the action of piston 78b for engaging high-speed forward-traveling clutch 78, i.e., for pressing friction disks 78f and 78g against one another. Further, when changeover valve 81 is disposed at the fluid-releasing position, changeover valve 81 supplies high-speed forward-traveling clutch 78 with fluid delivered from hydraulic pump 80 serving as lube for lubricating friction disks 78f and 78g, disk spring 78d and others. Lube pressure regulation valve 84 regulates the pressure of lube supplied to high-speed forward-traveling clutch 78.

Gearshift drive shaft 25 is axially bored therein with lube duct 25d in parallel to clutch fluid duct 25e. Lube duct 25d is opened to the front fluid chamber through a hole penetrating the center boss portion of drive rotor 78a. An orifice penetrates piston 78b is opened to the hole penetrating the center boss portion of drive rotor 78a, and to a fluid chamber incorporating disk spring 78d in the rear fluid chamber behind piston 78b. Lube duct 25d is opened at a rear end thereof into shaft casing 22i so as to receive fluid delivered from hydraulic pump 80 through a hole penetrating the wall of shaft casing 22i and changeover valve 81 disposed at the fluid-releasing position.

When changeover valve 81 is disposed at the fluid-supplying position, fluid is supplied into the clutch fluid chamber in the rear fluid chamber in drive rotor 78a, so that piston 78b slides rearward against disk spring 78d so as to separate friction disks 78f and 78g from one another, thereby disengaging high-speed forward-traveling clutch 78. When changeover valve 81 is disposed at the fluid-releasing position, fluid is drained from the clutch fluid chamber, so that piston 78b returns to the initial position due to the force of disk spring 78d so as to press friction disks 78f and 78g against one another, thereby engaging high-speed forward-traveling clutch 78. In this way, hydraulic high-speed forward-traveling clutch 78 drivingly connects or separates high-speed forward-traveling gear train 50H to and from gearshift drive shaft 25.

Incidentally, when changeover valve 81 is disposed at the fluid-releasing position, fluid is incompletely released from the clutch fluid chamber. The remaining fluid in the clutch fluid chamber flows toward the drum-shaped portion of drive rotor 78a by a centrifugal dynamic pressure caused by rotating gearshift drive shaft 25 during traveling of the vehicle. As a result, piston 78b slightly slides rearward away from friction disk 78f and 78g so as to reduce the pressure among friction disks 78f and 78g, thereby reducing the power transmission efficiency through clutch 78. Therefore, a vertical plate-shaped lid 78h is disposed at a rear end of high-speed forward-traveling clutch 78 so as to cover the rear end opening of the fluid chamber incorporating disk spring 78d behind piston 78b so as to increase the pressure of lube supplied into the fluid chamber incorporating disk spring 78d through lube duct 25d and the orifice of piston 78b, thereby preventing piston 78b from being slid rearward by the centrifugal dynamic pressure of the clutch fluid. Due to this structure, a proper pressure among friction disks 78f and 78g in high-speed forward-traveling clutch 78 is ensured during traveling of the vehicle so as to ensure a proper power transmission efficiency through clutch 78.

As shown in FIGS. 15 and 18, high-speed forward-traveling driven gear 51 is relatively unrotatably fitted on a rear end of forward-traveling driven shaft 27, and low-speed forward-traveling driven gear 52 is relatively rotatably fitted on forward-traveling driven shaft 27 through a bearing. A cylindrical member 52b is relatively unrotatably fitted on low-speed forward-traveling driven gear 52 and extended forward around forward-traveling driven shaft 27. Overrunning low-speed forward-traveling clutch 72 is disposed between cylindrical member 52b and forward-traveling driven shaft 27 so as to drivingly connect or separate low-speed forward-traveling gear train 50L to and from forward-traveling driven shaft 27. The structure of low-speed forward-traveling clutch 72 is the same as the above. FIG. 4 illustrating the structure of clutch 72 including sprags 72a is used as a sectional rear view of each of the eighth and ninth power transmission apparatuses shown in FIGS. 15 and 18.

When high-speed forward-traveling clutch 78 is disengaged, high-speed forward-traveling gear train 50H does not drive forward-traveling driven shaft 27 so that the rotary speed of forward-traveling driven shaft 27 is reduced, whereby sprags 72a automatically rise, i.e., low-speed forward-traveling clutch 72 is engaged. When high-speed forward-traveling clutch 78 is engaged, high-speed forward-traveling gear train 50H drives forward-traveling driven shaft 27 so that the rotary speed of forward-traveling driven shaft 27 is increased, whereby sprags 72a automatically lie, i.e., low-speed forward-traveling clutch 72 is disengaged.

Torque sensor 90 is provided around forward-traveling driven shaft 27 axially opposite to backward-traveling driven gear 55 with respect to spline hub 53 fixed on gearshift driven shaft 26. Forward-traveling driven shaft 27 is adapted to be drivingly connected to gearshift driven shaft 26 through torque sensor 90 and spline hub 53.

Torque sensor 90 will be described with reference to FIGS. 17(a) and (b). As mentioned above, forward-traveling clutch member 96 is relatively rotatably and axially unslidably fitted on the front end portion of forward-traveling driven shaft 27 through bearing 97, and is formed on a front end portion with clutch teeth 96a. A slider 91 is relatively unrotatably and axially slidably fitted on forward-traveling driven shaft 27 through roller balls 93 just behind forward-traveling clutch member 96. A disk spring 94 is interposed between slider 91 and cylindrical member 52b behind slider 91 so as to bias slider 91 toward forward-traveling clutch member 96. A fork 95 is fitted onto slider 91 so as to be operatively connected to an operation portion of changeover valve 81 through a linkage such as a link rod.

As noticed from FIG. 17(b), semispherical recesses 91a are formed on a front end surface of slider 91 so as to fit rear halves of respective balls 92, and recesses 96b are formed on a rear end surface of forward-traveling clutch member 96 so as to fit respective front halves of balls 92 and face respective recesses 91a. Each of recesses 96b has a semicircular deepest portion corresponding to the front half of ball 92, and extended from the deepest portion in opposite rotation directions around gearshift driven shaft 26 while being gradually shallower.

As mentioned above, reverser shifter 56 is axially slidably fitted on spline hub 53. When reverser shifter 56 is disposed at the forward-traveling position so as to mesh with clutch teeth 96a, the rotary force of gearshift drive shaft 25 is transmitted to forward-traveling driven shaft 27 through selected one of gear trains 50H and 50L, the rotary force of forward-traveling driven shaft 27 is transmitted to slider 91 through roller balls 93, and the rotary force of slider 91 is transmitted to gearshift driven shaft 27 through balls 92, forward-traveling clutch member 96, clutch teeth 96a, reverser shifter 96 and spline hub 53. Slider 91 is pressed against balls 92 by the force of disk spring 94. As shown in FIGS. 17(a) and (b), during normal traveling of the vehicle, balls 92 are fitted into the deepest portions of respective recesses 96b of forward-traveling clutch member 96 so that slider 91 rotates substantially integrally with forward-raveling clutch member 96. In this state, changeover valve 81 is disposed at the fluid-releasing position so as to engage high-speed forward-traveling clutch 78.

When reverser shifter 56 meshes with clutch teeth 96a and slider 91 rotates integrally with forward-traveling driven shaft 27, forward-traveling clutch member 96 rotates integrally with gearshift driven shaft 26. In this state, when an excessive road-load is applied onto gearshift driven shaft 26, the rotation of forward-traveling clutch member 96 and gearshift driven shaft 26 delays after the rotation of forward-traveling driven shaft 27, so that balls 92 ride the shallower portions of respective recesses 96b so as to push slide 91 rearward against disk spring 94, thereby switching changeover valve 81 to the fluid-supplying position for disengaging high-speed forward-traveling clutch 78.

In each of the eighth and ninth power transmission apparatuses, changeover valve 81 is mechanically connected to slider 91. Alternatively, changeover valve 81 may be an electromagnetic valve similar to those in the third, fourth sixth and seventh power transmission apparatuses. An electric switch may be switched by rearward sliding of slider 91 against disk spring 94 and a controller may switch changeover valve 81 based on the switching of the electric switch.

Low-speed forward-traveling clutch 72 and high-speed forward-traveling clutch 78 are contradictorily engaged and disengaged. It is assumed that reverser shifter 56 is disposed at the forward-traveling position so as to rotatably integrate forward-traveling driven shaft 27 with gearshift driven shaft 26. When high-speed forward-traveling clutch 78 is engaged, high-speed forward-traveling drive gear 25a is rotatably integrated with gearshift drive shaft 25 so as to transmit power to gearshift driven shaft 26 through high-speed forward-traveling gear train 50H. Meanwhile, with respect to low-speed forward-traveling gear train 50L, low-speed forward-traveling drive gear 25b fixed on gearshift drive shaft 25 transmits the rotation of gearshift drive shaft 25 to low-speed forward-traveling driven gear 52, however, low-speed forward-traveling driven gear 52 freely rotates relative to forward-traveling driven shaft 27 and gearshift driven shaft 26 because low-speed forward-traveling clutch 72 is disengaged.

On the same assumption, when low-speed forward-traveling clutch 72 is engaged, low-speed forward-traveling driven gear 52 constantly receiving the rotary force of gearshift drive shaft 25 is rotatably integrated with forward-traveling driven shaft 27 so as to transmit power from gearshift drive shaft 25 to gearshift driven shaft 26 through low-speed forward-traveling gear train 50L and forward-traveling driven shaft 27. Meanwhile, with respect to high-speed forward-traveling gear train 50H, high-speed forward-traveling driven gear 51 fixed on forward-traveling driven shaft 27 transmits the rotation of forward-traveling driven shaft 27 to high-speed forward-traveling drive gear 25a, however, high-speed forward-traveling drive gear 25a freely rotates relative to gearshift drive shaft 25 because high-speed forward-traveling clutch 78 is disengaged. In this way, due to the contradictory engagement and disengagement of clutches 72 and 78, unselected one of gear trains 50H and 50L idles.

In the tenth power transmission apparatus shown in FIG. 19, as mentioned above, high-speed gear train 50H and low-speed gear train 50L are interposed in parallel between gearshift drive shaft 25 and counter shaft 28, and forward-traveling gear train 50F and backward-traveling gear train 50R are interposed in parallel between counter shaft 28 and gearshift driven shaft 26. High-speed drive gear 25a relatively rotatably provided on gearshift drive shaft 25 meshes with high-speed driven gear 28a fixed on counter shaft 28 so as to constitute high-speed gear train 50H. Hydraulic high-speed clutch 78, similar to hydraulic high-speed forward-traveling clutch 78 of each of the eighth and seventh power transmissions, is provided on gearshift drive shaft 25 so as to drivingly connect or separate high-speed drive gear 25a to and from gearshift drive shaft 25. Low-speed drive gear 25b relatively unrotatably provided on gearshift drive shaft 25 meshes with low-speed driven gear 28b provided on counter shaft 28 through low-speed clutch 72 so as to constitute low-speed gear train 50L.

High-speed clutch 78 and low-speed clutch 72 are contradictorily engaged and disengaged. Low-speed driven gear 28b receives the rotary force of low-speed drive gear 25b fixed on gearshift drive shaft 25. When high-speed clutch 78 is engaged, the rotation of gearshift drive shaft 25 is transmitted to counter shaft 28 through engaged high-speed clutch 78 and gears 25a and 28a, thereby rotating low-speed driven gear 28b. Meanwhile, since low-speed clutch 72 is disengaged, the rotation of low-speed driven gear 28b is prevented from being transmitted to counter shaft 28, thereby being prevented from resisting the rotation of counter shaft 28 by power transmitted from gearshift drive shaft 25 through engaged high-speed clutch 78 and gears 25a and 28a.

When low-speed clutch 72 is engaged, the rotation of low-speed driven gear 28b is transmitted to high-speed drive gear 25a through counter shaft 28 and high-speed driven gear 28a. Meanwhile, since high-speed clutch 78 is disengaged, the rotation of high-speed drive gear 25a is prevented from being transmitted to gearshift drive shaft 25, thereby being prevented from resisting the rotation of gearshift drive shaft 25.

As mentioned above, high-speed driven gear 28a also serves as forward-traveling drive gear 28a of forward-traveling gear train 50F, and directly meshes with forward-traveling driven gear 29 relatively rotatably fitted on gearshift driven shaft 26. With respect to backward-traveling gear train 50R, backward drive gear 28c fixed on counter shaft 28 meshes with backward-traveling driven gear 55 relatively rotatably fitted on gearshift driven shaft 26 through idle gear 57.

The above-mentioned rearwardly extended center boss portion of forward-traveling driven gear 29 is relatively rotatably fitted on gearshift driven shaft 26, and torque sensor 90 (including forward-traveling clutch member 96 at the rear end thereof) is provided around the center boss portion of forward-traveling driven gear 29 so as to control changeover valve 81 for hydraulic high-speed clutch 78. Spline hub 53 is fixed on gearshift driven shaft 26 between the rear end of forward-traveling driven gear 29 and the front end of backward-traveling driven gear 55, and reverser shifter 56 is spline-fitted on spline hub 53 and shiftable among the neutral position for meshing with only spline hub 53, the forward-traveling position for meshing with clutch teeth 96a on forward-traveling clutch member 96, and the backward-traveling position for meshing with clutch teeth 55a on backward-traveling driven gear 55, as mentioned above.

Counter shaft 28 receives power from gearshift drive shaft 25 through either high-speed gear train 50H or low-speed gear train 50L due to the contradictory engagement and disengagement of clutches 78 and 72. When reverser shifter 56 is disposed at the forward-traveling position, forward-traveling gear train 50F is drivingly connected to gearshift driven shaft 26 through torque sensor 90, so that changeover valve 81 is controlled due to the condition of torque sensor 90. In this way, during forward traveling of the vehicle, either the high-speed traveling (due to engagement of clutch 78 and disengagement of clutch 72) or the low-speed traveling (due to disengagement of clutch 78 and engagement of clutch 72) is selected.

When reverser shifter 56 is disposed at the backward-traveling position, backward-traveling gear train 50R is drivingly connected to gearshift driven shaft 26 without torque sensor 90. Even if a large road-load is applied onto gearshift driven shaft 26, forward-traveling clutch member 96 is separated from reverser shifter 56 rotatably integrated with gearshift driven shaft 26 through spline hub 53, so that forward-traveling clutch member 96 is prevented from rotating relative to forward-traveling driven gear 29 by the torque of gearshift driven shaft 26. Accordingly, balls 92 are still held in the deepest portions of respective recesses 96b by the force of disk spring 94 disposed on slider 91, thereby keeping changeover valve 81 at the fluid-releasing position. As a result, during backward traveling of the vehicle, high-speed clutch 78 is constantly engaged, so that the rotation of gearshift drive shaft 25 is transmitted to gearshift driven shaft 26 through high-speed gear train 50H and backward-traveling gear train 50R. Similarly, in the later-discussed eleventh power transmission apparatus of FIG. 20, high-speed clutch 74H is constantly engaged regardless of torque sensor 90 when reverser shifter 96 is disposed at the backward-traveling position (however, the position of changeover valve 81 for engaging high-speed clutch 74H is the fluid-supplying position).

In the tenth power transmission apparatus shown in FIG. 19, front output shaft 6 is divided into an inner front output shaft 6a and an outer front output shaft 6b. Output shafts 6a and 6b are disposed in parallel. A gear casing 22k projects forward from the front end surface of middle casing part 22b offset from the portion of middle casing part 22b serving the rear part of CVT casing 2. In gear casing 22k, inner front output shaft 6a is journalled at a front end thereof, and outer front output shaft 6b is journalled at a rear end thereof. A gear 6c is fixed on inner front output shaft 6a, a gear 6e is fixed on outer front output shaft 6b, and gears 6c and 6e mesh with each other through an idle gear 6d.

Therefore, outer front output shaft 6b is appropriately arranged correspondingly to front axle casing 16 shown in FIGS. 1 and 2, so as to simplify the power train (including propeller shaft 8) from outer front output shaft 6b to input shaft 17a of differential gear unit 17 in front axle casing 16, thereby reducing costs. Further, due to the appropriate arrangement of outer front output shaft 6b, if universal joint 8a is interposed between propeller shaft 8 and each of shafts 6b and 17a, a bent angle of universal joint 8a is reduced so as to enhance the power transmission efficiency, reduce noise, and have other effects. More preferably for reducing costs, outer front output shaft 6b is disposed coaxially to input shaft 17a so as to require no universal joint.

In the eleventh power transmission apparatus shown in FIG. 20, similar to the sixth power transmission apparatus shown in FIG. 12, hydraulic clutch device 74, including high-speed clutch 74H and low-speed clutch 74L, is disposed on gearshift drive shaft 25 between high-speed drive gear 25a and low-speed drive gear 25b relatively rotatably provided on gearshift drive shaft 25. The structure of hydraulic clutch device 74 and of fluid ducts 25d and 25e in gearshift drive shaft 25, such as to contradictorily engage and disengage clutches 74H and 74L, is the same as that shown in FIG. 12, except that hydraulic clutch device 74 of FIG. 20 is provided at a front portion thereof with high-speed clutch 74H and at a rear portion thereof with low-speed clutch 74L.

In the eleventh power transmission apparatus, high-speed driven (i.e., forward-traveling drive) gear 28a is fixed on counter shaft 28, and meshes with high-speed drive gear 25a, so as to constitute high-speed gear train 50H adapted to be drivingly connected to gearshift drive shaft 25 through high-speed clutch 74H. In parallel to high-speed gear train 50H, low-speed driven gear 28b is fixed on counter shaft 28, and meshes with low-speed drive gear 25b, so as to constitute low-speed gear train 50L adapted to be drivingly connected to gearshift drive shaft 25 through low-speed clutch 74L. Similar to forward-traveling gear train 50F and backward-traveling gear train 50R in the tenth power transmission apparatus shown in FIG. 19, forward-traveling gear train 50F, including mutually meshing gears 28a and 29, and backward-traveling gear train 50R, including mutually meshing gears 28c, 57 and 55, are extended from counter shaft 28 in parallel, so that forward-traveling gear train 50F is adapted to be drivingly connected to gearshift driven shaft 26 through torque sensor 90 and the reverser clutch (including reverser shifter 56 and spline hub 53), and backward-traveling gear train 50R is adapted to be drivingly connected to gearshift driven shaft 26 through the reverser clutch without torque sensor 90.

If the eleventh power transmission apparatus shown in FIG. 20 employs the hydraulic circuit system shown in FIG. 17(a), the relation of condition of torque sensor 90 to the position of changeover valve 81 should be reversed. In this regard, when torque sensor 90 exists in a normal state, i.e., unless torque sensor 90 detects an excessive road-load, changeover valve 81 is disposed at the fluid-supplying position so as to supply fluid into the clutch fluid chamber for pushing piston 74b forward to press friction disks 74d and 74e of high-speed clutch 74H against one another. Due to the forward motion of piston 74b, connection pin 74c moves forward together with piston 74b so as to separate friction disks 74f and 74g of low-speed clutch 74L from one another. When torque sensor 90 exists in an abnormal state, i.e., when torque sensor 90 detects an excessive road-load, changeover valve 81 is disposed at the fluid-releasing position so as to release fluid from the clutch fluid chamber for returning piston 74b rearward due to the force of spring 74j, thereby separating friction disks 74d and 74e of high-speed clutch 74H from one another. Then, connection pin 74c moves rearward together with piston 74b so as to press friction disks 74f and 74g of low-speed clutch 74L against one another.

Instead of the mechanical connection between clutches 74H and 74L, including connection pin 74c, the switching timings of respective clutches 74H and 74L may be electrically controlled so as to contradictorily engage and disengage clutches 74H and 74L.

Alternatively, each of the third, fourth, sixth and seventh power transmission apparatuses of FIGS. 8, 10, 12 and 13, including respective hydraulic high-speed clutches 73, 74H and 75, may be adapted to have torque sensor 90 provided on forward-traveling driven shaft 27, so that the rotation of forward-traveling driven shaft 27 driven by either high-speed forward-traveling gear train 50H or low-speed forward-traveling gear train 50L is transmitted to gearshift driven shaft 26 through torque sensor 90 and reverser shifter 56 disposed at the forward-traveling position.

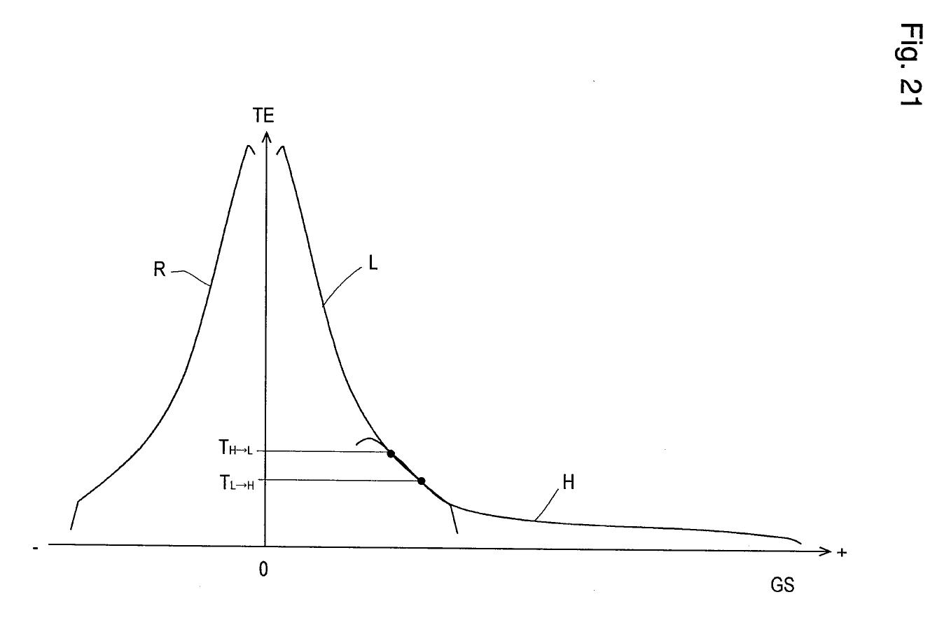

Among the eighth to eleventh power transmission apparatuses shown in FIGS. 15 and 18 to 20 including gear transmission 50, which gearshifts based on the road-load (torque) detection, especially, with respect to the eighth and ninth power transmission apparatuses shown in FIGS. 15 and 18, a driving performance due to the clutch control of gear transmission 50, that is, the relation of traction effort TE (corresponding to the road-load) to ground speed GS, will be described with reference to FIG. 21, however, description of the above-mentioned contents about FIG. 14 will be omitted.

The vehicle travels by the driving of low-speed forward-traveling gear train 50L only in abnormal cases such that it climbs a steep slope (whose slope rate exceeds 30%) and that it travels with a heavy load. Torque sensor 90 is set so as to be switched to its abnormal condition only in the abnormal cases of the vehicle, i.e., so as to keep its normal condition when the vehicle normally starts, when the vehicle travels with a normal load, and when the vehicle climbs a slope whose slope rate does not exceed 30%. In other words, unless a road-load applied onto the vehicle is increased to a value caused in the abnormal cases, the road-load is not regarded as being excessive.

In this regard, torque sensor 90 is set so that, when a road-load (to which traction effort TE corresponds) is increased as indicated by graph H and reaches a value TH→L, torque sensor 90 is switched from the normal condition to the abnormal condition so as to switch changeover valve 81 from the position for engaging high-speed clutch 78 to the position for disengaging high-speed clutch 78. Value TH→L is defined as the maximum traction effort TE due to the driving of high-speed forward-traveling gear train 50H, which matches with a road-load applied on the vehicle climbing a 30% slope, or with a maximum road-load applied on the vehicle with a normal load, whereby the vehicle can efficiently travel with the driving of high-speed forward-traveling gear train 50H unless an ascending slope rate exceeds 30% or unless the vehicle travels with abnormally heavy load.

When the vehicle climbs a slope whose slope rate exceeds 30% or when the vehicle travels with abnormally heavy load, an excessive road-load occurs so as to switch torque sensor 90 to the abnormal condition, so that high-speed forward-traveling clutch 78 is disengaged, and then low-speed forward-traveling clutch 72 is engaged, whereby the vehicle can travel at a low speed with high traction effort TE exceeding value TH→L corresponding to the excessive road-load due to the driving of low-speed forward-traveling gear train 50L as indicated by graph L.

When an excessive road-load (to which traction effort TE exceeding value TH→L corresponds) is reduced and reaches value TH→L, torque sensor 90 is switched from the abnormal condition to the normal condition so as to switch changeover valve 81 from the position for disengaging high-speed clutch 78 to the position for engaging high-speed clutch 78. Value TL→H is defined as the minimum traction effort TE due to the driving of low-speed forward-traveling gear train 50L. Value TL→H is larger than value TH→L so as to establish a hysteresis range about gearshift of gear transmission 50, thereby preventing excessively frequent gearshift and ensuring a stable driving performance.

In this regard, while gear transmission 50 is set at the high speed stage (where high-speed forward-traveling clutch 78 is engaged and low-speed forward-traveling clutch 72 is disengaged), if a road-load is increased and the increased road-load (to which traction effort TE corresponds) exists in the hysteresis range, the high speed stage is kept. That is, the speed stage is switched from the high speed stage to the low speed stage (where high-speed forward-traveling clutch 78 is disengaged and low-speed forward-traveling clutch 72 is engaged) only after traction effort TE corresponding to the road-load exceeds the maximum value TH→L of the hysteresis range. On the other hand, while gear transmission 50 is set at the low speed stage, if a road-load is reduced and the reduced road-load exists in the hysteresis range, the low speed stage is kept. That is, the speed stage is switched from the low speed stage to the high speed stage only after traction effort TE corresponding to the road-load becomes lower than the minimum value TL→H of the hysteresis range.

Further, ground speed GS due to the driving of low-speed forward-traveling gear train 50L is lower than a half value of the maximum ground speed GS so as to make the high speed stage more frequent than the low speed stage, thereby ensuring an efficient main traveling of the vehicle due to the driving of high-speed forward-traveling gear train 50H, and thereby reducing fuel consumption.

Referring to graph R, when reverser shifter 56 is set at the backward-traveling position, backward traveling gear train 50R transmits power to gearshift driven shaft 26 without torque sensor 90. Due to the driving of backward-traveling gear train 50R, high traction effort TE relative to ground speed GS is ensured during backward traveling of the vehicle, whereby the ground speed range due to backward traveling gear train 50R is lower than that due to high-speed forward-traveling gear train 50H for the normal forward traveling of the vehicle (regardless of whether it is plus or minus in FIG. 21). For example, the characteristic of traction effort TE relative to ground speed GS during backward traveling of the vehicle is substantially equal to that during forward traveling of the vehicle with the driving of low-speed forward-traveling gear train 50L.

With respect to each of the tenth and eleventh power transmission apparatuses shown in FIGS. 19 and 20, the driving performance during forward traveling of the vehicle is represented by graphs H and L in FIG. 21. When the vehicle travels backward, the driving performance depends on the gearshift between high-speed gear train 50H (through constantly engaged high-speed clutch 78 or 74H) and backward-traveling gear train 50R, however, high-speed clutch 78 or 74H is not controlled based on torque sensor 90. Alternatively, each of the tenth and eleventh power transmission apparatuses may be configured so as to select one of high-speed and low-speed gear trains 50H and 50L to be driven during backward traveling of the vehicle.

In each of the eighth to eleventh power transmission apparatuses, the detection of road-load for switching the high-speed clutch depends on mechanical torque sensor 90 disposed on the downstream side of both high-speed gear train 50H and low-speed gear train 50L in gear transmission 50. To controlling changeover valve 81 for switching the high-speed clutch, a distortion gauge or another alternative device for detecting an excessive torque corresponding to road-load may be disposed on the downstream side of gear transmission 50. Alternatively, a detection device for detecting an excessive engine rotary speed exceeding a rated engine rotary speed may be provided for controlling changeover valve 81.

A twelfth power transmission apparatus will be described with reference to FIGS. 9 and 22 to 24. In CVT 40, belt 43 slips against input pulley 41 or output pulley 42 when an excessive load is applied onto belt 43, so that a rotary speed of a second (driven side) shaft of CVT 40, i.e., gearshift drive shaft 25, is reduced lower than a proper value corresponding to the set deceleration ratio of CVT 40 and a rotary speed of a first (drive side) shaft of CVT 40, i.e., main drive shaft 23. Therefore, in the twelfth power transmission apparatus, the high-speed clutch is controlled based on detection of rotary speeds of the first and second shafts of CVT 40, i.e., main drive shaft 23 and gearshift drive shaft 26.

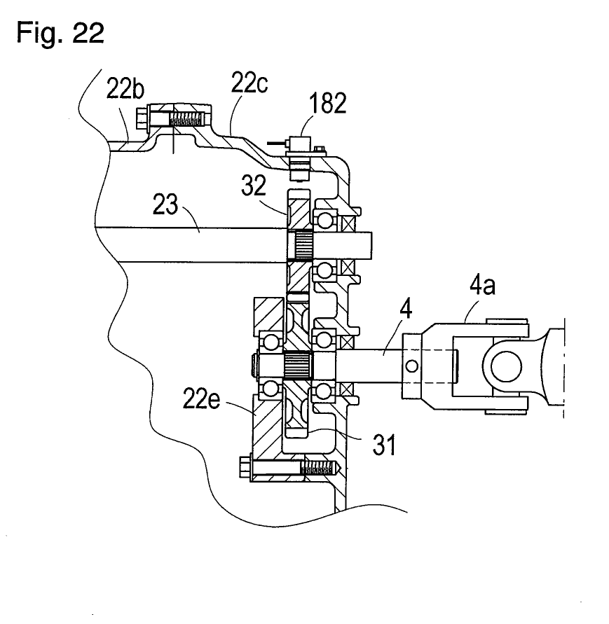

FIG. 22 illustrates a rotary speed sensor 182 adapted for the twelfth power transmission apparatus. Rotary speed sensor 182 is attached onto gear transmission casing 3 (rear casing part 22c) so as to detect a rotary speed of main drive shaft 23 serving as the first shaft of CVT 40.

Among the first to eleventh transmission apparatuses, each of the third and fourth power transmission apparatuses shown in FIGS. 8 and 10, which has rotary speed sensor 82 attached to gear transmission casing 3 (rear casing part 22c) so as to detect the rotary speed of gearshift drive shaft 25 as shown in FIG. 9, can be provided with rotary speed sensor 182 attached onto gear transmission casing 3 as shown in FIG. 22 so as to control changeover valve 81 for switching high-speed forward-traveling clutch 73 based on the rotary speeds detected by respective rotary speed sensors 82 and 182, thereby serving as the twelfth power transmission apparatus.

Each of the sixth and seventh power transmission apparatuses shown in FIGS. 12 and 13 can also be provided with rotary speed sensors 82 and 182 attached onto gear transmission casing 3, as shown in FIGS. 9 and 22, so as to control changeover valve 81 for switching high-speed forward-traveling clutch 74H or 75, thereby serving as the twelfth power transmission apparatus. Further, each of the eighth to eleventh power transmission apparatuses shown in FIGS. 15 and 18 to 20 can cancel torque sensor 90 and be provided with rotary speed sensors 82 and 182 attached onto gear transmission casing 3, as shown in FIGS. 9 and 22, so as to control changeover valve 81 for switching high-speed forward-traveling clutch 74H or 75, thereby serving as the twelfth power transmission apparatus.

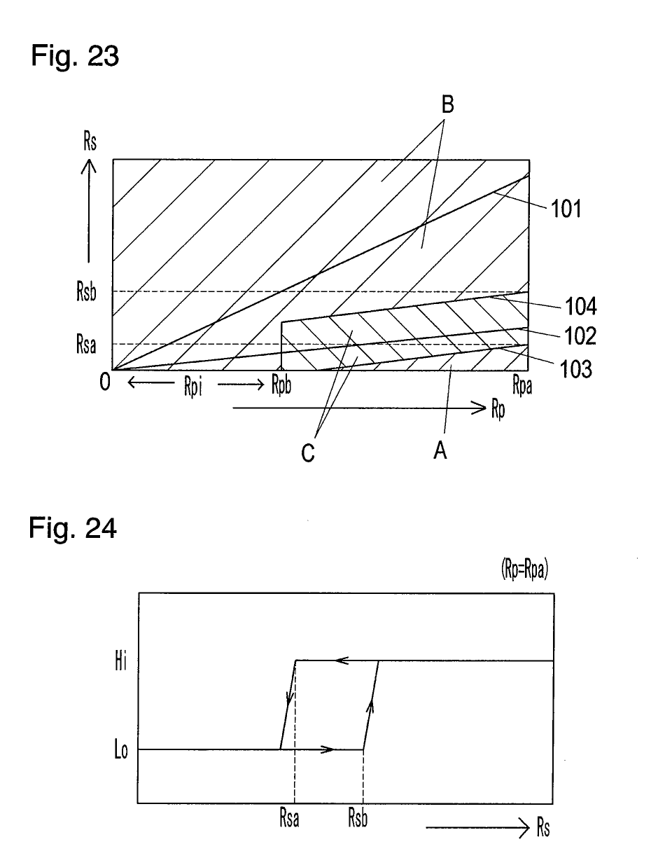

The twelfth power transmission apparatus employs maps shown in FIGS. 23 and 24 so as to establish a hysteresis in control of the high-speed and low-speed clutches in gear transmission 50 based on detection of the rotary speeds of the first and second shafts of CVT 40. Referring to FIG. 23, in CVT 40, a second shaft rotary speed Rs relative to a first shaft rotary speed Rp varies between a value represented by a characteristic line 101 and a value represented by characteristic line 102. In other words, when first shaft rotary speed Rs is kept constant, second shaft rotary speed Rs varies between the maximum value represented by characteristic line 101 and the minimum value represented by characteristic line 102.

A characteristic line 103 represents second shaft rotary speed Rs for disengaging the high-speed clutch having been engaged, that is lower than the value represented by characteristic line 102. For example, characteristic line 103 is parallel to characteristic line 102. In the case that the rotary speed Rp of the first shaft of CVT 40 (main drive shaft 23) which is substantially rotatably integral with output shaft 1a of prime mover 1 is kept to be a maximum (rated) rotary speed Rpa, the high-speed clutch having been engaged is disengaged when rotary speed Rs of the second shaft of CVT 40 (gearshift drive shaft 25) is reduced and becomes lower than a value Rsa. Therefore, referring to FIG. 23, gear transmission 50 is always set in the low speed stage while first shaft rotary speed Rp and second shaft rotary speed Rs exist in a range A.

A characteristic line 104 represents second shaft rotary speed Rs for engaging the high-speed clutch having been disengaged, that is higher than the value represented by characteristic line 102. For example, characteristic line 104 is parallel to characteristic line 102. However, characteristic line 104 is not effective unless first shaft rotary speed Rp is equal or more than a starting rotary speed Rpb, because gear transmission apparatus 50 is set in the high speed stage regardless of variation of second shaft rotary speed Rs while first shaft rotary speed Rp exists in an idle rotary speed range Rpi lower than starting rotary speed Rpb. In the case that the rotary speed Rp of the first shaft of CVT 40 (main drive shaft 23) is kept to be maximum (rated) rotary speed Rpa, the high-speed clutch having been disengaged is engaged when the rotary speed Rs of the second shaft of CVT 40 (gearshift drive shaft 25) is increased and becomes higher than a value Rsb. Therefore, referring to FIG. 23, gear transmission 50 is always set in the high speed stage while first shaft rotary speed Rp and second shaft rotary speed Rs exist in a range B.

Referring to FIG. 23, a range C between ranges A and B is a hysteresis range about first shaft rotary speed Rp and second shaft rotary speed Rs. Even if second shaft rotary speed Rs having existed in range B is reduced into hysteresis range C, the high-speed clutch is not disengaged. The high-speed having been engaged is disengaged so as to set gear transmission 50 into the low speed stage only when second shaft rotary speed Rs is reduced into range A through hysteresis range C. Even if second shaft rotary speed Rs having existed in range A is increased into hysteresis range C, the high-speed clutch is not engaged. The high-speed having been disengaged is engaged so as to set gear transmission 50 into the high speed stage only when second shaft rotary speed Rs is increased into range B through hysteresis range C.

FIG. 24 indicates a relation of a speed stage of gear transmission 50 relative to second shaft rotary speed Rs while the first shaft of CVT 40 (main drive shaft 23) is driven at maximum (rated) rotary speed Rpa, on the assumption that the speed stage of gear transmission 50 is controlled to correspond to detected first shaft rotary speed Rp and second shaft rotary speed Rs according to the map of FIG. 23. It is assumed that gear transmission 50 is set in a high speed stage Hi. Even if second shaft rotary speed Rs is reduced and becomes lower than value Rsb, high speed stage Hi of gear transmission 50 is kept while reduced second shaft rotary speed Rs is still higher than value Rsa. The speed stage of gear transmission 50 is switched from high speed stage Hi to a low speed stage Lo when reduced second shaft rotary speed Rs becomes lower than value Rsa. On the contrary, it is assumed that gear transmission 50 is set in a low speed stage Lo. Even if second shaft rotary speed Rs is increased and becomes higher than value Rsa, low speed stage Lo of gear transmission 50 is kept while reduced second shaft rotary speed Rs is still lower than value Rsb. The speed stage of gear transmission 50 is switched from low speed stage Lo to high speed stage Hi when increased second shaft rotary speed Rs becomes higher than value Rsb.

It is further understood by those skilled in the art that the foregoing description is a preferred embodiment of the disclosed apparatus and that various changes and modifications may be made in the invention without departing from the spirit and scope thereof.

1. A power transmission apparatus interposed between a prime mover and an axle, comprising:
(a) an automatic continuously variable belt transmission serving as a main transmission; and
(b) a gear transmission serving as a sub-transmission, the sub-transmission including
(c) input means for receiving power from the main transmission,
(d) output means for outputting power to the axle,
(e) a first gear train interposed between the input means and the output means so as to have a first deceleration ratio,
(f) a first clutch disposed on the first gear train so as to be engaged when a rotary speed of the input means is not smaller than a threshold value,
(g) a second gear train interposed between the input means and the output means so as to have a second deceleration ratio which is different from the first deceleration ratio, and
(h) a second clutch disposed on the second gear train so as to be engaged unless the first clutch is engaged.

2. The power transmission apparatus according to claim 1, wherein the first gear train serves as a high-speed gear train, and the second gear train serves as a low-speed gear train.

3. The power transmission apparatus according to claim 1, wherein the first clutch is a centrifugal clutch.

4. The power transmission apparatus according to claim 1, wherein the first clutch is a hydraulic clutch.

5. The power transmission apparatus according to claim 1, wherein the second clutch is an overrunning clutch.

6. The power transmission apparatus according to claim 1, wherein the second clutch is a hydraulic clutch.

7. The power transmission apparatus according to claim 1, wherein the second clutch is a dog clutch.

8. The power transmission apparatus according to claim 1, further comprising:
(a) a centrifugal clutch disposed on the upstream side of the sub-transmission, wherein the centrifugal clutch is disengaged when a rotary speed of the prime mover exists within an idle rotary speed range and wherein the centrifugal clutch is engaged when the rotary speed of the prime mover exceeds the idle rotary speed range.

9. (canceled)

10. The power transmission apparatus according to claim 8, further comprising:
(a) an overrunning clutch, wherein, when a rotary speed of the upstream side of the centrifugal clutch is lower than a rotary speed of the downstream side of the centrifugal clutch, the overrunning clutch is engaged to transmit power bypassing the centrifugal clutch.

11. The power transmission apparatus according to claim 8, further comprising:
(a) a regulation gear train disposed on the upstream side of the main transmission so as to regulate a rotary speed of power from the prime mover inputted to the main transmission.

12. The power transmission apparatus according to claim 11, wherein the centrifugal clutch is interposed between the regulation gear train and the main transmission.

13. The power transmission apparatus according to claim 8, wherein the centrifugal clutch is interposed between the main transmission and the sub-transmission.

14. The power transmission apparatus according to claim 1, wherein a vehicle speed for switching between the first gear train and the second gear train is set in a range lower than a half of the maximum vehicle speed.

15. The power transmission apparatus according to claim 1, the sub-transmission further including:
(a) a third gear train for transmitting power bypassing the first and second gear trains to the output means, wherein a direction of rotation of the output means driven by the third gear train is different from a direction of rotation of the output means driven by either of the first and second gear trains; and
(b) a third clutch disposed on the third gear train.

16. The power transmission apparatus according to claim 15, wherein the third gear train has a third deceleration ratio which is larger than one of the first and second deceleration ratios that is smaller than the other of the first and second deceleration ratios.

17. The power transmission apparatus according to claim 1, wherein the main transmission is disposed opposite to the prime mover with respect to the sub-transmission.

18. The power transmission apparatus according to claim 17, wherein the sub-transmission supports the main transmission and is vibro-isolatedly mounted on a vehicle frame.

19. The power transmission apparatus according to claim 17, further comprising:
(a) a cover enclosing substantially all over the main transmission.

20. A power transmission apparatus interposed between a prime mover and an axle, comprising:
(a) an automatic continuously variable belt transmission serving as a main transmission; and
(b) a gear transmission serving as a sub-transmission, the sub-transmission including
(c) input means for receiving power from the main transmission,
(d) output means for outputting power to the axle,
(e) a first gear train interposed between the input means and the output means so as to have a first deceleration ratio,
(f) a first clutch disposed on the first gear train so as to be disengaged when a road-load applied onto the axle is not smaller than a threshold value,
(g) a second gear train interposed between the input means and the output means so as to have a second deceleration ratio which is different from the first deceleration ratio, and
(h) a second clutch disposed on the second gear train so as to be engaged when the first clutch is disengaged.

21. The power transmission apparatus according to claim 20, further comprising:
(a) detection means disposed on the downstream side of the first and second gear trains so as to detect the load applied onto the axle, wherein the first clutch is engaged or disengaged based on a value of load detected by the detection means.

22. The power transmission apparatus according to claim 20, wherein the first gear train serves as a high-speed gear train, and the second gear train serves as a low-speed gear train.

23. The power transmission apparatus according to claim 20, wherein, in the main transmission, a belt is interposed between a first shaft connected to the prime mover and a second shaft connected to the sub-transmission, and the belt slips when the main transmission is overloaded, the power transmission apparatus further comprising:
(a) first detection means for detecting a rotary speed of the first shaft; and
(b) second detection means for detecting a rotary speed of the second shaft, wherein the first clutch is engaged or disengaged based on detection values of the first and second detection means.

24. The power transmission apparatus according to claim 23, wherein the first gear train serves as a high-speed gear train, and the second gear train serves as a low-speed gear train.

25. The power transmission apparatus according to claim 24, wherein, when a rotary speed of the first shaft is constant, a detected rotary speed of the second shaft defined for disengaging the first clutch having been engaged is smaller than a detected rotary speed of the second shaft defined for engaging the first clutch having been disengaged.

26. The power transmission apparatus according to claim 20, wherein the first clutch is a hydraulic clutch.

27. The power transmission apparatus according to claim 20, wherein the second clutch is an overrunning clutch.

28. The power transmission apparatus according to claim 20, wherein the first and second clutches are wet disk clutches.

29. The power transmission apparatus according to claim 20, further comprising:
(a) a centrifugal clutch disposed on the upstream side of the sub-transmission, wherein the centrifugal clutch is disengaged when a rotary speed of the prime mover exists within an idle rotary speed range, and wherein the centrifugal clutch is engaged when the rotary speed of the prime mover exceeds the idle rotary speed range.

30. The power transmission apparatus according to claim 29, further comprising:
(a) an overrunning clutch, wherein, when a rotary speed of the upstream side of the centrifugal clutch is lower than a rotary speed of the downstream side of the centrifugal clutch, the overrunning clutch is engaged to transmit power bypassing the centrifugal clutch.

31. The power transmission apparatus according to claim 29, further comprising:
(a) a regulation gear train disposed on the upstream side of the main transmission so as to regulate a rotary speed of power from the prime mover inputted to the main transmission.

32. The power transmission apparatus according to claim 31, wherein the centrifugal clutch is interposed between the regulation gear train and the main transmission.

33. The power transmission apparatus according to claim 29, wherein the centrifugal clutch is interposed between the main transmission and the sub-transmission.

34. The power transmission apparatus according to claim 20, wherein a vehicle speed for switching between the first gear train and the second gear train is set in a range lower than a half of the maximum vehicle speed.

35. The power transmission apparatus according to claim 20, the sub-transmission further including:
(a) a third gear train for transmitting power bypassing the first and second gear trains to the output means, wherein a direction of rotation of the output means driven by the third gear train is different from a direction of rotation of the output means driven by either of the first and second gear trains; and
(b) a third clutch disposed on the third gear train.

36. The power transmission apparatus according to claim 35, wherein the third gear train has a third deceleration ratio which is larger than one of the first and second deceleration ratios that is smaller than the other of the first and second deceleration ratios.

37. The power transmission apparatus according to claim 20, wherein the main transmission is disposed opposite to the prime mover with respect to the sub-transmission.

38. The power transmission apparatus according to claim 37, wherein the sub-transmission supports the main transmission and is vibro-isolatedly mounted on a vehicle frame.

39. The power transmission apparatus according to claim 37, further comprising:
(a) a cover enclosing substantially all over the main transmission.

40. A power transmission apparatus interposed between a prime mover and an axle, comprising:
(a) an automatic continuously variable belt transmission serving as a main transmission;
(b) a gear transmission serving as a sub-transmission driven by the main transmission; and
(c) a centrifugal clutch disposed on the upstream side of the sub-transmission, wherein the centrifugal clutch is disengaged when a rotary speed of the prime mover exists within an idle rotary speed range, and wherein the centrifugal clutch is engaged when the rotary speed of the prime mover exceeds the idle rotary speed range.

41. The power transmission apparatus according to claim 40, further comprising:
(a) an overrunning clutch, wherein, when a rotary speed of the upstream side of the centrifugal clutch is lower than a rotary speed of the downstream side of the centrifugal clutch, the overrunning clutch is engaged to transmit power bypassing the centrifugal clutch.

42. The power transmission apparatus according to claim 40, further comprising:
(a) a regulation gear train disposed on the upstream side of the main transmission so as to regulate a rotary speed of power from the prime mover inputted to the main transmission.

43. The power transmission apparatus according to claim 42, wherein the centrifugal clutch is interposed between the regulation gear train and the main transmission.

44. The power transmission apparatus according to claim 40, wherein the centrifugal clutch is interposed between the main transmission and the sub-transmission.

45. A power transmission apparatus disposed in front or rear of a prime mover of a vehicle and between front and rear axles so as to transmit power from the prime mover to the front and rear axles, the power transmission apparatus comprising:
(a) an automatic continuously variable belt transmission;
(b) a second transmission driven by the belt transmission;
(c) a casing incorporating the second transmission, wherein the belt transmission is disposed opposite to the prime mover with respect to the casing in the fore-and-rear direction of the vehicle; and
(d) input means for transmitting power from the prime mover to the belt transmission, wherein the input means is supported by the casing so as to penetrate the casing through front and rear surfaces of the casing.

46. The power transmission apparatus according to claim 45, further comprising:
(a) a cover enclosing substantially all over the belt transmission.

47. The power transmission apparatus according to claim 45, the second transmission including:
(a) a front output shaft for transmitting power to the front axle; and
(b) a rear output shaft for transmitting power to the rear axle, wherein either a propeller shaft connecting the front output shaft to the front axle or a propeller shaft connecting the rear output shaft to the rear axle is disposed on either left or right side of the prime mover.

48. The power transmission apparatus according to claim 45, the input means including:
(a) a regulation gear train disposed in the casing so as to regulate a rotary speed of power from the prime mover inputted to the belt transmission.
